(19) United States
(12) Patent Application Publication
(10) Pub. No.: US 2011/0321172 A1
(43) Pub. Date: Dec. 29, 2011

(54) MANAGEMENT APPARATUS, LICENSE MANAGEMENT SERVER, ELECTRONIC EQUIPMENT, ELECTRONIC EQUIPMENT MANAGEMENT SYSTEM, MANAGEMENT METHOD, PROGRAM, AND RECORDING MEDIUM

(76) Inventors: Hiroshi MAEDA, Kanagawa (JP); Toru Harada, Kanagawa (JP)

(21) Appl. No.: 13/169,273

(22) Filed: Jun. 27, 2011

(30) Foreign Application Priority Data
Jun. 28, 2010 (JP) 2010-146266

(51) Int. Cl. G06F 21/22; G06F 1/24

(52) U.S. Cl. 726/27; 713/100

(57) ABSTRACT

A management apparatus has a storage unit that stores software information and license information. The management apparatus periodically acquires software information introduced into an information processing apparatus communicably connected to the management apparatus from the information processing apparatus and compares the software information with the software information in the storage unit. Upon detecting any difference between the software information, the management apparatus notifies a user of the detection of a change in software configuration and updates the corresponding software information in the storage unit with the acquired software information. Then, upon detecting the change request of the software configuration from the user, the management apparatus makes a request to the information processing apparatus for changing the software configuration using the corresponding license information in the storage unit and notifies the user of the result of the request.

### BACKGROUND OF THE INVENTION

1. Field of the Invention

The present invention relates to various electronic equipment including an information processing apparatus such as an image reading apparatus (a scanner or the like) capable of performing communications, an image forming apparatus (a digital multifunction peripheral, a digital copier, a FAX machine, a printer, or the like), a personal computer, and an in-vehicle information processing apparatus; a management apparatus that manages the electronic equipment; a license management server that manages a license for using specific software in the electronic equipment; an electronic equipment management system having the electronic equipment and the management apparatus; a management method of the management apparatus; a program that causes a computer controlling the management apparatus to implement a required function (the function relating to this invention); and a computer-readable recording medium in which the program is recorded.

2. Description of the Related Art

Software installed in the information processing apparatus as described above includes firmware that performs basic control of hardware, plug-ins (small programs) that provide the functions of the information processing apparatus, or the like. If the software is provided as the firmware or the plug-in, its addition, update, deletion, or the like can be easily realized. Further, if the respective plug-ins installed in the information processing apparatus are designed such that “they are made available upon their activation (when a license is applied) and are not made available upon their deactivation (when the license is canceled),” it is also possible to restrict available functions on a plug-in basis. Hereinafter, addition, update, deletion, activation, deactivation, or the like of software are collectively referred to as “change in software configuration,” “change in software,” or “update of software.”

Meanwhile, in order to change the software configuration of an information processing apparatus, it is expected to provide a system in which a management apparatus capable of being connected to the information processing apparatus via a network is installed and a change in software configuration is requested by the management apparatus. As such a system, an information processing apparatus management system has been known in which a management apparatus periodically verifies the version of software installed in each of information processing apparatuses and updates the software to keep the version up-to-date if the version is not the latest.

However, such a conventional system has a problem in that although the version of the software can be kept up-to-date, “the management apparatus cannot detect and recover an unintended change in software configuration if it is made by a subject other than the management apparatus.” The unintended change by the subject other than the management apparatus represents that addition, update, deletion, activation, deactivation, or the like of the software is erroneously performed by, for example, the operation unit of the information processing apparatus. Nevertheless, the change in software configuration cannot be detected only by the verification of the version of the software installed in the information processing apparatus by the management apparatus.

In order to solve this problem, use of the technology disclosed in Patent Document 1 is assumed.

Patent Document 1 discloses an image forming apparatus management system that manages an image forming apparatus via a network for the purpose of saving effort and time for updating the firmware of the image forming apparatus. In this system, a management apparatus (client) makes a request to the image forming apparatus for sending the version of the firmware, and the image forming apparatus returns the current version of the firmware to the management apparatus in response to the request. Then, the management apparatus compares the version with the version of firmware recorded in an external recording unit to determine whether it is the latest one. If it is not the latest one, the management apparatus reads the firmware of the latest version from the external recording unit and sends it to the image forming apparatus so that the image forming apparatus updates the firmware.

However, even the system disclosed in Patent Document 1 cannot solve the problem in that “the management apparatus cannot detect and recover an unintended change in software configuration if it is made by a subject other than the management apparatus.”

The present invention has been made in view of the above point and may have an object of enabling a management apparatus to detect and recover an unintended change in software configuration by a subject other than the management apparatus in electronic equipment capable of being connected to the management apparatus.
Patent Document 1: JP-A-2002-288066

### SUMMARY OF THE INVENTION

In order to achieve the above object, the present invention provides a management apparatus, a license management server, electronic equipment, an electronic equipment management system having the electronic equipment and the management apparatus, a management method of the management apparatus, a program executed by a computer that controls the management apparatus, and a computer-readable recording medium in which the program is recorded.

According to an aspect of the present invention, there is provided a management apparatus that manages electronic equipment connected via a connection unit, the management apparatus including the connection unit configured to be communicably connected to the electronic equipment; a storage unit configured to store software information and license information; an information acquisition unit configured to periodically acquire software information introduced into the electronic equipment from the electronic equipment; a difference detection unit configured to compare the software information acquired by the information acquisition unit with the software information stored in the storage unit and to detect a difference between the respective software information; a change-detection notification unit configured to notify a user of a detection of a change in a software configuration when the difference is detected by the difference detection unit; an information update unit configured to update the corresponding software information stored in the storage unit with the software information acquired by the information acquisition unit; a request detection unit configured to detect a change request of the software configuration from the user; a change request unit configured to make a request to the electronic equipment for changing the software configuration with the corresponding license information stored in the storage unit when the request detection unit detects the change request of the software configuration; and a request-result notification unit configured to notify the user of a result of the request by the change request unit.

According to another aspect of the present invention, there is provided an electronic equipment management system including a license management server and electronic equipment each having a connection unit communicably connected to the management apparatus described above. The license management server includes a license information storage unit configured to store license information composed of the product key, the product ID, the expiration date, an unissued license number, an issued license number, and the equipment-unique information on the electronic equipment, a license file issuance unit configured to generate the license file including the corresponding product ID, the equipment-unique information, and the expiration date stored in the license information storage unit based on the product key and the equipment-unique information and transmit the same to the management apparatus, to decrement the corresponding unissued license number stored in the license information storage unit by one, and to increment the corresponding issued license number stored in the license information storage unit by one, when receiving the product key and the equipment-unique information together with the issuance request of the license file from the management apparatus, and a license return unit configured to increment the corresponding unissued license number stored in the license information storage unit by one and to decrement the corresponding issued license number stored in the license information storage unit by one, when receiving the product ID and the equipment-unique information together with the return request of the license from the management apparatus. The electronic equipment includes an equipment-unique information storage unit configured to store the equipment-unique information on the electronic equipment, an equipment-unique information notification unit configured to notify the management apparatus of the equipment-unique information stored in the equipment-unique information storage unit, when receiving an equipment-unique information provision request from the management apparatus, an equipment-unique information determination unit configured to determine whether the equipment-unique information constituting the license file and the equipment-unique information stored in the equipment-unique information storage unit match each other, when receiving the license file together with the activation request of the software from the management apparatus, and an activation processing unit configured to perform activation processing when the equipment-unique information determination unit determines that both of the equipment-unique information match each other.

According to still another aspect of the present invention, there is provided a management method of a management apparatus that has a connection unit communicably connected to electronic equipment and a storage unit storing software information and license information and that manages the electronic equipment connected via the connection unit. The management method includes an information acquisition step of periodically acquiring software information introduced into the electronic equipment from the electronic equipment; a difference detection step of comparing the software information acquired in the information acquisition step with the software information stored in the storage unit and detecting a difference between the respective software information; a change-detection notification step of notifying a user of a detection of a change in a software configuration when the difference is detected in the difference detection step; an information update step of updating the corresponding software information stored in the storage unit with the software information acquired in the information acquisition step; a request detection step of detecting a change request of the software configuration from the user; and a change request step of making a request to the electronic equipment for changing the software configuration with the corresponding license information stored in the storage unit when the change request of the software configuration is detected in the request detection step.

Other objects, features and advantages of the present invention will become more apparent from the following detailed description when read in conjunction with the accompanying drawings.

### BRIEF DESCRIPTION OF THE DRAWINGS

FIG. 1 is a conceptual diagram showing a network configuration example of an information processing apparatus management system as an embodiment of an electronic apparatus management system including a management apparatus according to the present invention;

FIG. 2 is a block diagram showing a hardware configuration example of the management apparatus 102 shown in FIG. 1;

FIG. 3 is an explanatory diagram showing an example of software information acquirable from an information processing apparatus shown in FIG. 1;

FIG. 4 is an explanatory diagram showing an example of license management information held by a management server 104 shown in FIG. 1;

FIG. 5 is an explanatory diagram showing an example of the form of a license file issued by the management server 104 shown in FIG. 1;

FIG. 6 is an explanatory diagram showing an example of updating the license management information held by the license management server 104 shown in FIG. 1;

FIG. 7 is an explanatory diagram showing an example of license information stored in a storage unit 203 of the management apparatus 102 shown in FIG. 1;

FIG. 8 is a sequence diagram showing an example of an operating sequence periodically performed in the information processing apparatus management system shown in FIG. 1;

FIG. 9 is a flowchart showing an example of the procedure of comparing software information (S802) by the management apparatus 102 shown in FIG. 1;

FIG. 10 is a sequence diagram showing an example of an operating sequence performed when a plug-in addition request is made in the information processing apparatus management system shown in FIG. 10;

FIG. 11 is a sequence diagram showing an example of an operating sequence performed when a plug-in deletion request is made in the information processing apparatus management system shown in FIG. 1;

FIG. 12 is a sequence diagram showing an example of an operating sequence performed when a plug-in activation request is made in the information processing apparatus management system shown in FIG. 1;

FIG. 13 is a sequence diagram showing an example of an operating sequence performed when a plug-in deactivation request is made in the information processing apparatus management system shown in FIG. 1;

FIG. 14 is a sequence diagram showing an example of an operating sequence performed when a deactivation remand request is made in the information processing apparatus management system shown in FIG. 1;

FIG. 15 is a sequence diagram showing an example of an operating sequence performed when an activation remand request is made in the information processing apparatus management system shown in FIG. 1;

FIG. 16 is a conceptual diagram showing a network configuration example of an image forming apparatus management system as a first reference example of the present invention;

FIG. 17 is a block diagram showing a logical configuration example of main hardware and software inside image forming apparatuses 1 through 4 shown in FIG. 16;

FIG. 18 is a block diagram showing a configuration example of the hardware inside the image forming apparatuses 1 through 4 shown in FIG. 16;

FIG. 19 is a sequence diagram showing an example of an operating sequence at user authentication by the respective units of the image forming apparatuses 1 through 4 shown in FIG. 17;

FIG. 20 is a sequence diagram showing an example of an operating sequence at the application of correction data by the respective units of the image forming apparatuses 1 through 4 shown in FIG. 17;

FIG. 21 is a sequence diagram showing another example of the operating sequence at the application of the correction data by the respective units of the image forming apparatuses 1 through 4 shown in FIG. 17;

FIG. 22 is a sequence diagram showing an example of an operating sequence at the notification of a status change from external equipment;

FIG. 23 is a sequence diagram showing an example of an operating sequence at the application of correction data from the external equipment;

FIG. 24 is a sequence diagram showing an example of an operating sequence at the cancellation of the user authentication by the respective parts of the image forming apparatuses 1 through 4 shown in FIG. 17;

FIG. 25 is a flowchart showing an example of processing for verifying correction-data application propriety by an input/output control unit 11, an execution program control unit 19, and the like shown in FIG. 17;

FIGS. 26A through 26E are explanatory diagrams showing a structure example of data stored in a storage unit 14 and a memory 23 shown in FIG. 18;

FIG. 27 is a diagram showing a display example of a correctable program search screen in an operation panel;

FIG. 28 is a diagram showing a display example of a correction object program selection screen;

FIG. 29 is a diagram showing a display example of a screen indicating that a correction program is being applied;

FIG. 30 is a diagram showing a display example of a screen indicating that authentication is being cancelled;

FIG. 31 is a diagram showing a display example of a screen where the application of correction data is selected; and

FIG. 32 is an explanatory diagram for explaining a change in a correction object program on the memory 14 shown in FIG. 18.

### DETAILED DESCRIPTION OF THE PREFERRED EMBODIMENTS

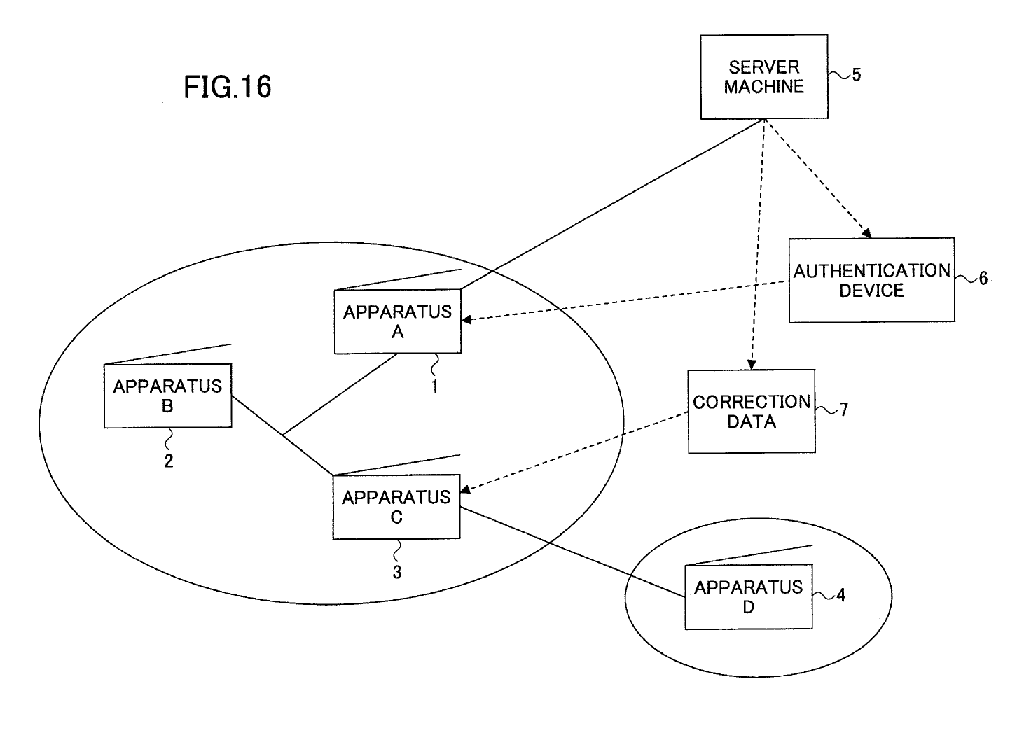

Prior to describing an embodiment of the present invention, a description is given of reference examples and their corresponding problems with reference to FIGS. 16 through 32 for convenience of understanding.

In a case where a problem occurs in electronic equipment (machine) and is caused by firmware, it is necessary to correct a program constituting the firmware. Generally, the source code of the program is examined to solve the program after the occurrence of the problem, and then the program is regenerated so that the firmware of the machine is updated.

However, this results in the occurrence of two problems at the same time. A first problem is that it takes time to examine the source code. A second problem resides in the update of the firmware.

In most cases, problems in installing the source code are not written in specifications, and it becomes more difficult to specify the problems if the program is more complicated. In addition, as for the update of the firmware, there is a case that it is difficult for an input/output apparatus such as a server machine and an image forming apparatus to temporarily stop the machine in consideration of a downtime.

It has been known that these problems can be solved by a technology that dynamically changes (or just changes) the program. In order to solve the first problem in which it takes time to examine the source code, an examination program is supplied to the operating machine having the problem so that the operations of the program and the values of variables are examined. Further, in order to solve the second problem residing in the update of the firmware, the program is corrected (changed). Thus, the problem can be eliminated without stopping the machine.

On the other hand, a technology for changing the program is a method for replacing a part of the program. Further, there are two methods in applying the technology to the image forming apparatus. One method is that the server machine and the image forming apparatus are communicably connected to each other via a network and the program is supplied from the server machine to the image forming apparatus. The other method is that the program is supplied to the image forming apparatus via an external recording medium or the like.

When the program is dynamically changed, either of the methods give rise to problems in security. The problems in the former case are (a) and (b) described below, and the problems in the latter case are (c) and (d) described below.

(a) A problem in authentication of the server machine

(b) A problem in falsification of the program on the network

(c) A problem in falsification of the program on the external recording medium

(d) A problem in authentication of a user

These four problems can be solved according to general authentication methods.

The problem in (a) can be solved by connection authentication such as the exchange of a certificate between the server machine and the image forming apparatus.

The problems in (b) and (c) can be solved by the authentication of the program like an electronic signature.

(d) The problem in (d) can be solved by the authentication of the user (personal authentication) such as password authentication.

When security is strengthened by the above authentication methods, a problem in usability occurs in turn. Specifically, this problem is seen in a case in which an electronic signature or the like is generated via an authentication apparatus such as a server machine for the authentication of the program and is downloaded again to be installed in the equipment.

In this case, the user is required to access the authentication apparatus every time he/she corrects the program, which in turn degrades a corresponding speed as a convenience of the dynamic program. In addition, the equipment adversely affects the behavior of the program if it authenticates the program every time the program is started. As a result, the processing ability of the equipment is reduced, and the reproduction of the problem is not performed.

In view of the problems, a method is provided to apply a technology for changing a dynamic program while saving user's trouble relating to authentication of the program as much as possible.

An example of a basic scenario as the solving method is as follows.

1. An authentication apparatus performs user registration in accordance with a user's operation, sets personal authentication, and generates user authentication information (hereinafter also referred to as “user information” or “authentication information”) using an encrypted electronic certificate (or an ID+a password or the like) corresponding to a registered user.

2. The authentication apparatus cancels limitations on a specified program in accordance with a user's operation. At this time, by the specification of, for example, a program capable of being dynamically changed, the specified program can be made into be the program of which the limitations are canceled. Since the program can be corrected (rewritten) by correction data (also referred to as “program correction data” or a “correction program”), information (such as the name of the program) on the program is generated as correction object program information.

3. The authentication apparatus adds the correction object program information to the generated authentication information and writes it in an external recording medium specified by the user as user authentication data.

4. The authentication apparatus generates correction data for dynamically changing the program of which the limitations are canceled in accordance with a user's operation. At this time, the correction data may be included in the user authentication data.

5. Upon insertion of the external recording medium, an image forming apparatus performs personal authentication (user authentication) by using the authentication information included in the user authentication data written in the external recording medium.

6. The authentication apparatus gives the generated correction data to the image forming apparatus in accordance with a user's operation.

7. If the above personal authentication is successful, the image forming apparatus applies the correction data to a program based on the correction object program information added to the user authentication data written in the external recording medium in a case where the correction data given by the authentication apparatus are applicable to the operating program. That is, the program is corrected by the correction data.

A description is given of variations of such a basic scenario in the following reference examples.

### First Reference Example

First, a description is given of the general outline of an image forming apparatus management system as a first reference example of the present invention. Note that the first reference example describes the application of data (correction data) for correcting a program in a single image forming apparatus.

FIG. 16 is a conceptual diagram showing a network configuration example of the image forming apparatus management system. Note that in the diagram, solid lines connecting respective apparatuses indicate network connections and broken lines indicate data flows.

In the image forming apparatus management system of the first reference example, a server machine 5 has the functions of both an authentication data generation unit that generates the authentication data (authentication information) of a user and a correction data generation unit that generates correction data for dynamically changing a program. However, the respective functions may be arranged in other server machines.

A circle surrounding the image forming apparatuses shown in FIG. 16 indicates a group of the image forming apparatuses. In the first reference example, the circle indicates the application range of correction data. In FIG. 16, since an authentication device 6 is attached to the image forming apparatus 1, the correction data 7 are applied to the image forming apparatuses 1 through 3 but cannot be applied to the image forming apparatus 4.

The correction data 7 are introduced into the image forming apparatuses 1 through 3 via a detachable external recording medium (not shown) or a network.

Next, a description is given of a logical configuration example of main hardware and software inside the image forming apparatuses 1 through 4 shown in FIG. 16. Note that processing and control by the software (a hardware control layer and a system management layer) described below are actually performed when a CPU operates in accordance with the software. However, for convenience, the following description assumes that the software performs the processing. Hereinafter, same applies to cases in which the software performs any processing and control.

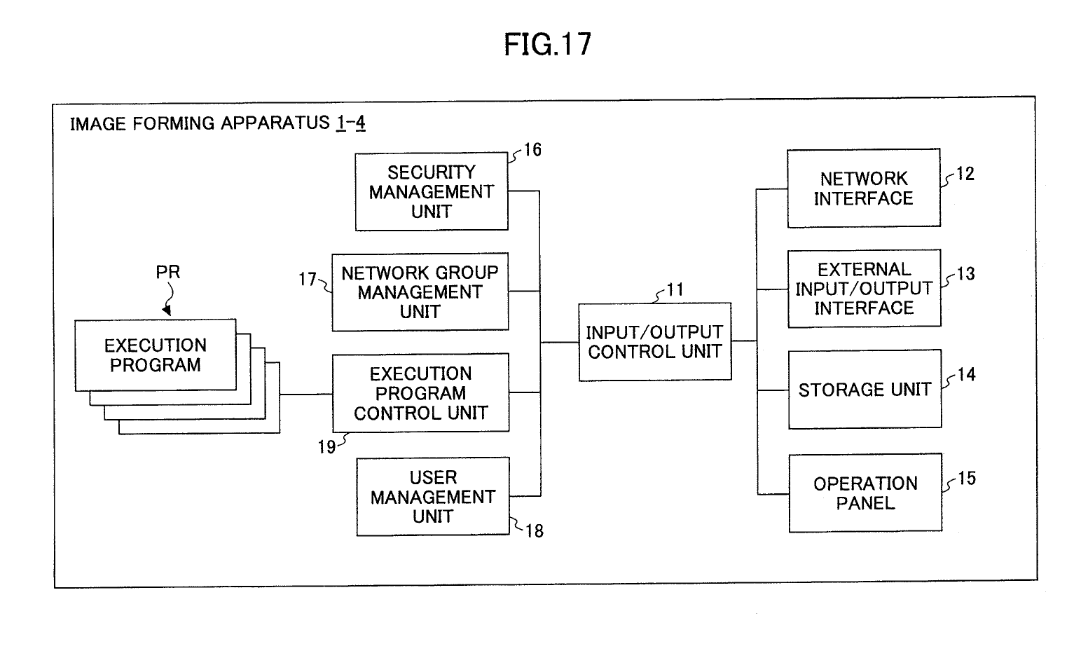

FIG. 17 is a block diagram showing the logical configuration example of the main hardware and software inside the image forming apparatuses 1 through 4 shown in FIG. 16.

The image forming apparatuses 1 through 4 are those such as digital multifunction peripherals (MFPs), digital copiers, FAX machines, and printers, and they are each composed of a hardware layer (on the rightmost column), a hardware control layer (on the second column from the right), a system management layer (on the second column from the left), and an application layer (on the leftmost column) as shown in FIG. 17.

The hardware control layer originally exists in each hardware. However, since there is no difference in providing the hardware control layer for each hardware, it is collectively regarded as an input/output control unit 11 in the first reference example.

A network interface (hereinafter an “interface” is also referred to as an “I/F”) 12 is a connection unit communicably connected to external equipment such as the server machine 5 shown in FIG. 16 via a network such as a LAN (Local Area Network).

An external input/output interface 13 is a connection unit communicably connected to a detachable external recording medium such as a USB and a SD card.

A storage unit 14 is a non-volatile storage unit such as a HDD (Hard Disk Drive Unit) for maintaining data (software including various programs) inside the image forming apparatus (hereinafter also referred to as “equipment”).

An operation panel 15 allows the user to perform an input/output, and has a display unit such as a LCD or a CRT and various operation keys (also referred to as operation switches or operation buttons) with which the user inputs data such as operating instructions to an image forming part (an engine) and the external equipment based on the selection of functions provided by the equipment. The display unit may have a touch panel on its front surface, wherein the touch panel displays an operation screen for allowing the user to use the various functions. By selectively pressing (touching) keys on the screen, the user can instruct the equipment to perform a corresponding operation.

In the first reference example, a security management unit 16 records a dynamic change in correctable (changeable) execution program (hereinafter also simply referred to as a “program”) PR such as an application and firmware, operations of the changed execution program PR, and authentication of the user.

In the first reference example, a network group management unit 17 searches for other image forming apparatuses connected to a network in which the execution program PR can be dynamically changed.

A user management unit 18 authenticates the user. The user management unit 18 performs the user authentication by using input authentication information (an electronic certificate, an ID, a password, or the like) and previously acquired authentication information. For example, in the case of common password authentication, the user management unit 18 compares input authentication information (an ID+a password or only a password) with previously acquired authentication information for verification, and determines that the user authentication is successful if both of the authentication information match each other and determines that the user authentication fails if they do not match each other.

An execution program control unit 19 records information indicating whether the execution program PR can be dynamically changed, manages a memory for dynamically changing the executing program PR and scheduling for executing the execution program PR, and dynamically changes the execution program PR.

Besides, there are various functions for executing, for example, a copying operation inside the equipment. However, programs, a system management unit, and hardware beyond the description of the first reference example are omitted in the figure.

Next, a description is given of the configuration example of the hardware inside the image forming apparatuses 1 through 4 shown in FIG. 16.

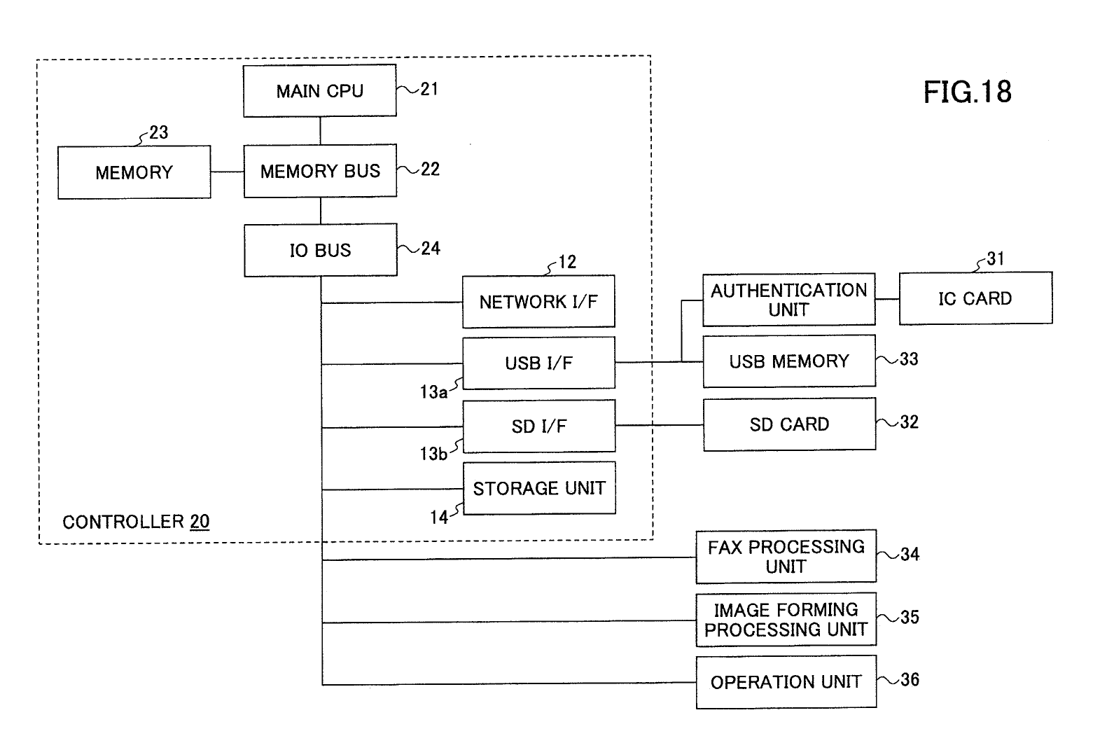

FIG. 18 is a block diagram showing the configuration example of the hardware inside the image forming apparatuses 1 through 4, and the same units as those of FIG. 17 are denoted by the same reference numerals.

As the hardware constituting a controller 20 that collectively controls respective units, each of the image forming apparatuses 1 through 4 actually has a main CPU 21, a memory bus 22, a memory 23, and an IO bus 24 as shown in FIG. 18 in addition to the network I/F 12, the storage unit 14, and the like shown in FIG. 17.

The main CPU 21 is a calculation processing unit that performs various processing and control via the memory bus 22. As the main CPU 21 operates in accordance with software, it can realizes the functions of the security management unit 16, the network group management unit 17, the user management unit 18, and the execution program control unit 19 shown in FIG. 17.

The memory 23 is a storage unit such as a RAM and a flash memory used as a program area where the main CPU 21 develops various programs constituting the software in the storage unit 14, a work area used when the main CPU 21 performs processing, or the like.

A USB-I/F 13a and a SD-I/F 13b correspond to the external input/output interface 13 shown in FIG. 17, wherein an IC card 31 as an authentication unit and a SD card 32 can be connected to the USB-I/F 13a and the SD-I/F 13b, respectively. The IC card 31 is a device for inputting user information in which the changed range of correction data is recorded. The SD card 32 is a device for inputting correction data for dynamically changing a program to the equipment. The two devices can be replaced by a USB memory 33. Similarly, only the SD card 32 can play the two roles of the IC card 31 and the SD card 32.

A FAX processing unit 34 and an image forming processing unit 35 correspond to image forming units for realizing a FAX operation and a copying operation, respectively.

An operation unit 36 corresponds to the operation panel 15 shown in FIG. 17.

Note that there is a difference in the configuration of the hardware depending on a CPU architecture and a hardware manufacturer. However, the processing of the first reference example is free from a change in configuration unless there is no difference in the input/output devices in the basic configuration shown in FIG. 18.

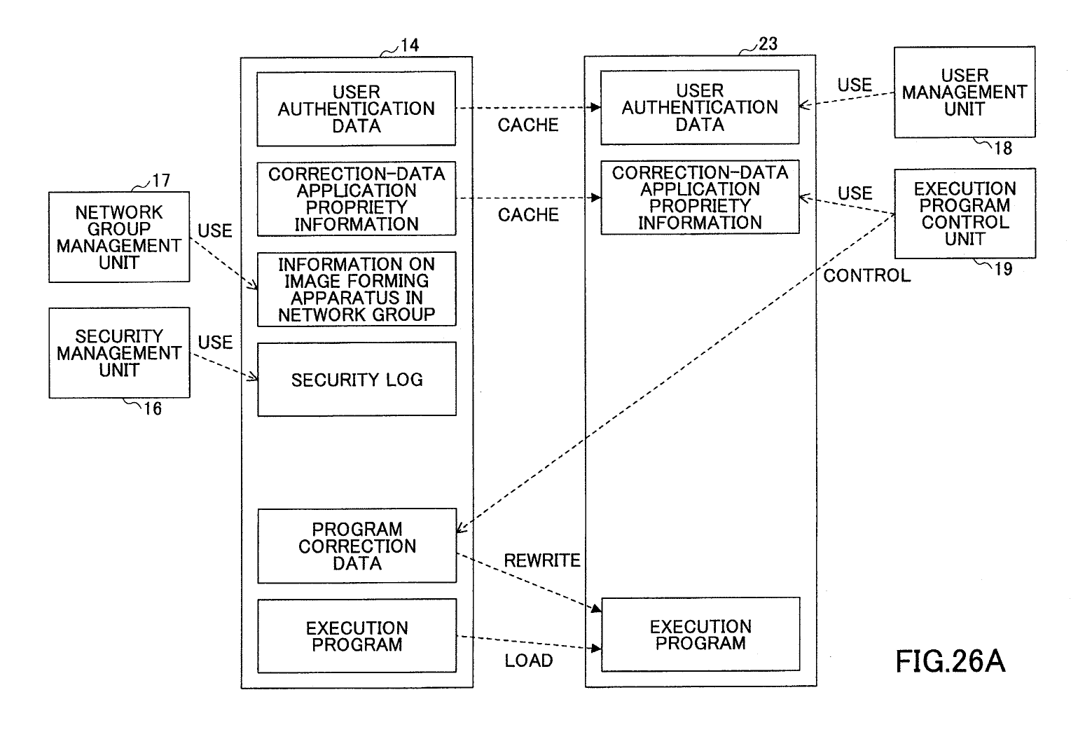

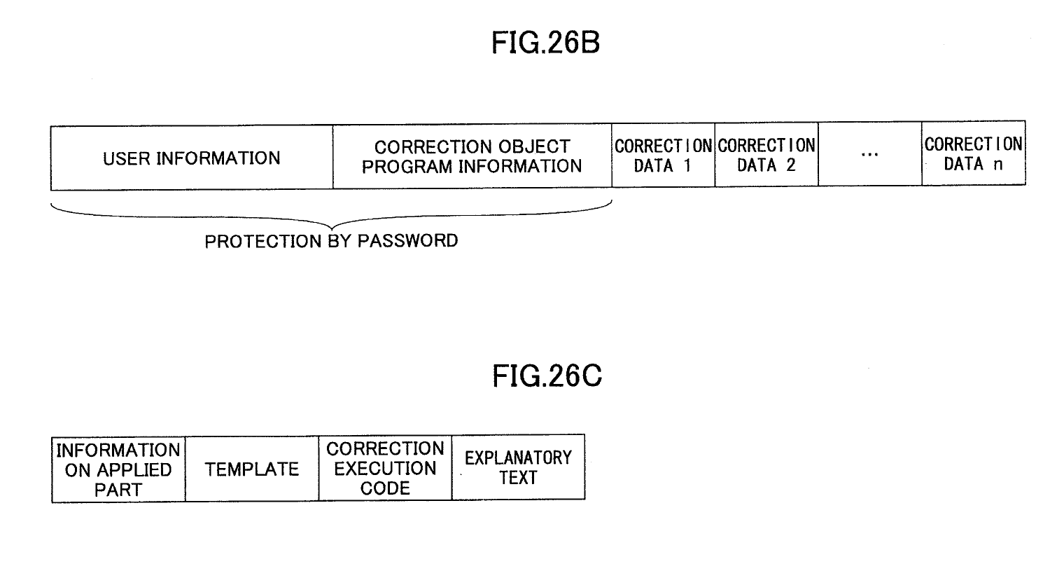

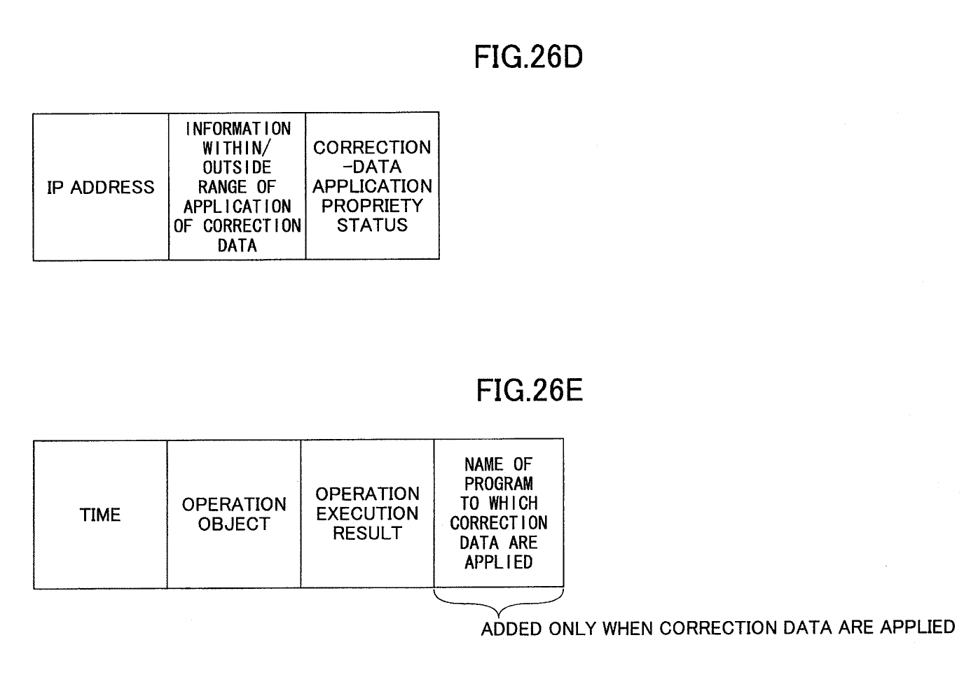

Next, a description is given of an example of an operating (processing and control) sequence at user authentication by the respective units of the image forming apparatuses 1 through 4 shown in FIG. 17. In this example, user authentication data having authentication information (user information) and correction object program information and an authentication device (external recording unit) in which correction data are recorded are used. However, as shown in, for example, FIG. 26B, the user authentication data may include the correction data.

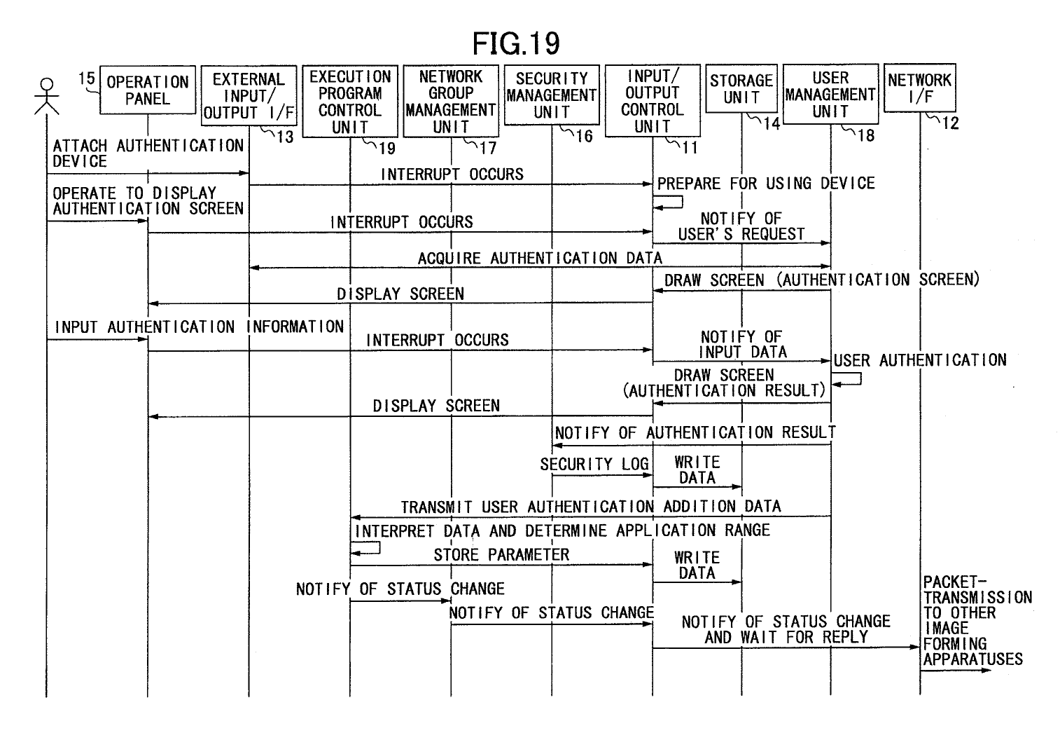

FIG. 19 is a sequence diagram showing the example of the operating sequence at the user authentication by the respective units of the image forming apparatuses 1 through 4 shown in FIG. 17.

For example, when the user (operator) inserts an authentication device such as the USB memory 33 and the SD card 32 into the system (equipment) as shown in FIG. 19, the external input/output interface 13 (USB-I/F 13a or SD-I/F 13b) detects the insertion of the authentication device and generates an interrupt signal indicating the insertion of the authentication device and outputs the interrupt signal to the input/output control unit 11, whereby the input/output control unit 11 make preparations for using the authentication device. The user authentication using the authentication information is started by the operation of the user (it is actually started when the user operates the operation panel 15).

Here, a general-purpose device such as the USB memory 33 and the SD card 32 is easily obtained in the market, and a security threat may occur in the system in a case where the authentication data are generated by the user. Therefore, it is assumed that the authentication data are generated by the server machine 5 shown in FIG. 16. In the network shown in FIG. 16, only one user is allowed to use the correction data. This is because if there are plural users, a program to which the correction data have been applied (that has been corrected by the correction data) may be further corrected by the users. The execution program control unit 19 or the user management unit (user authentication unit) 18 as one of the software in the system shown in FIG. 17 is designed not to allow the plural users to use the correction data (not shown).

As the user authentication, it is general to use a password authentication method. However, if the IC card 31 shown in FIG. 18 or the like with which a person can be identified in advance is used as the authentication device, it is possible to use other authentication methods.

When the user operates to display an authentication screen that allows the authentication information to be input on the operation panel (actually an indicator) 15 shown in FIG. 17 after the input/output control unit 11 makes the preparations for using the authentication device, the operation panel 15 produces an interrupt signal indicating the display request of the authentication screen and notifies the input/output control unit 11 of the display request. The input/output control unit 11 notifies the user management unit 18 of the display request of the authentication screen (user request).

In response to the display request of the authentication screen, the user management unit 18 notifies the external input/output interface 13 of the acquisition request of the user authentication data. Then, the user management unit 18 acquires the user authentication data including the authentication information on the authentication device via the external input/output interface 13, stores the (caches) the user authentication data in the memory 23 shown in FIG. 18, and instructs the input/output control unit 11 to draw (display) the authentication screen. Accordingly, the input/output control unit 11 displays the authentication screen on the operation panel 15.

Then, when the user inputs the authentication information, the operation panel 15 produces an interrupt signal indicating the authentication information and notifies the input/output control unit 11 of the interrupt signal. After that, the input/output control unit 11 notifies the user management unit 18 of the authentication information (input data).

Upon receiving the authentication information from the input/output control unit 11, the user management unit 18 makes the user authentication by using the authentication information and the authentication information included in the user authentication data of the memory 23, and instructs the input/output control unit to draw an authentication result screen as an operation screen for displaying the result of the authentication. Accordingly, the input/output control unit 11 displays the authentication result screen on the operation panel 15.

After instructing the input/output control unit 11 to draw the authentication result screen, the user management unit 18 notifies the security management unit 16 of the result of the user authentication. Accordingly, the security management unit 16 notifies the input/output control unit 11 of a security log including the result of the user authentication (operation execution result). The security log may include time (current time acquired from a time circuit or the like (not shown)) and information indicating an operation object as shown in, for example, FIG. 26E.

The input/output control unit 11 acquires the security log from the user management unit 18 and writes and stores the security log in the storage unit 14 as data.

After notifying the security management unit 16 of the result of the user authentication, the user management unit 18 notifies, if the result of the user authentication is “successful,” the execution program control unit 19 of the user authentication data (including the correction object program information) acquired from the authentication device as user authentication addition data. The correction object program information included in the user authentication data is information with which the user discriminates the range of an object program (program of which limitations are canceled) to which the correction data are applicable.

The execution program control unit 19 acquires the user authentication addition data from the user management unit 18, interprets the correction object program information included in the user authentication addition data, determines a list of object programs to which the correction data corresponding to the authentication user are applicable (the application range of the correction data), and limits (changes) the application range of the correction data where necessary. The system (actually the storage unit 14 shown in FIG. 17) maintains basic correction-data application propriety information in advance, which shows the list of the programs to which the correction data are applicable (the range of the system) and is stored (cached) in the memory 23 at the activation of the equipment as shown in FIG. 26A. Therefore, the execution program control unit 19 compares the range of the system with the determined application range of the correction data. If the determined application range of the correction data is smaller than the range of the system, the execution program control unit 19 limits the application range of the correction data to the application range concerned and notifies the input/output control unit 11 of the application range as the correction-data application propriety information (parameter) for the authentication user, which indicates the application range of (the list of the object programs to which the correction data corresponding to the authentication user are applicable) of the limited correction data.

The input/output control unit 11 acquires the correction-data application propriety information and writes and stores the correction-data application propriety information in the storage unit 14 as data.

In a case where the application range of the correction data is limited, the execution program control unit 19 regards as status change information the correction-data application propriety information for the authentication user, which is the limited application range of the correction data, and notifies the network group management unit 17, which handles the other image forming apparatuses in the same group to which the correction data are applicable (in which a program can be corrected by the correction data), of the status change information.

Upon receiving the status change information, the network group management unit 17 notifies the input/output control unit 11 of the status change information together with apparatus information (such as IP addresses) of the other image forming apparatuses in the same group.

Then, the input/output control unit 11 receives the status change information together with the apparatus information and notifies the network interface 12 of these information. Then, the input/output control unit 11 waits for a reply from the network interface 12.

Upon receiving the status change information together with the apparatus information from the input/output control unit 11, the network interface 12 packet-transmits the status change information to the other image forming apparatuses in the same group via a network based on the apparatus information and notifies (replies) the input/output control unit 11 of the result of the transmission.

Next, a description is given of an example of an operating sequence at the application of correction data by the respective units of the image forming apparatuses 1 through 4 shown in FIG. 17. In this example, it is assumed that the authentication device records plural correction data.

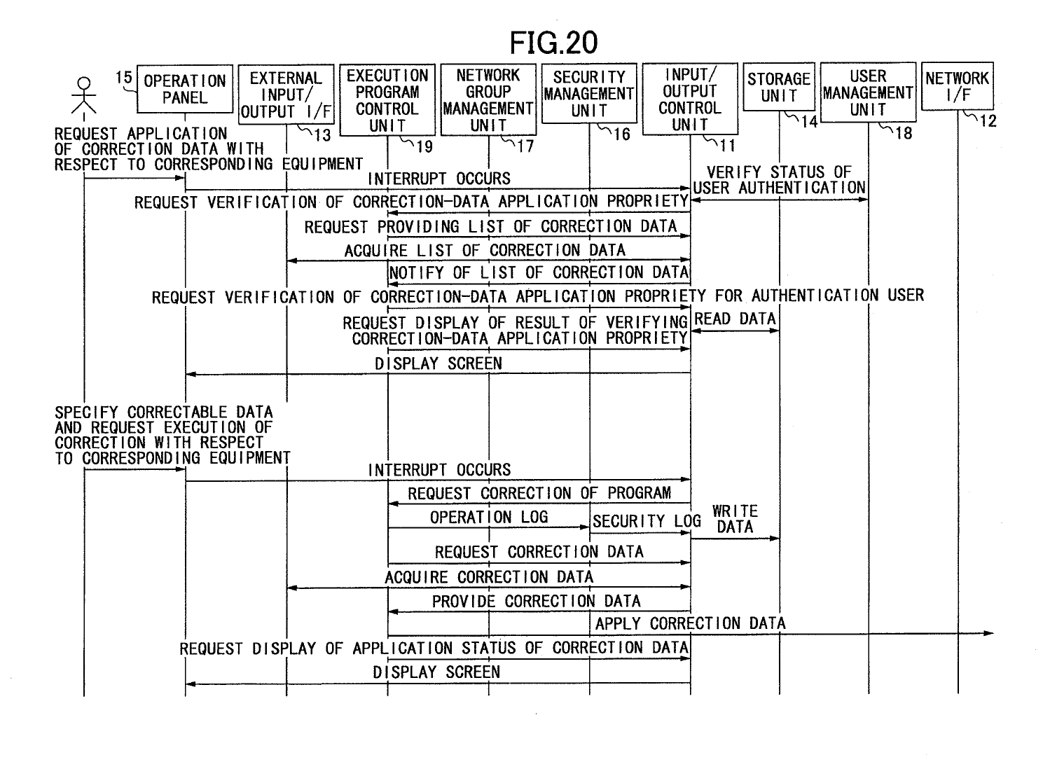

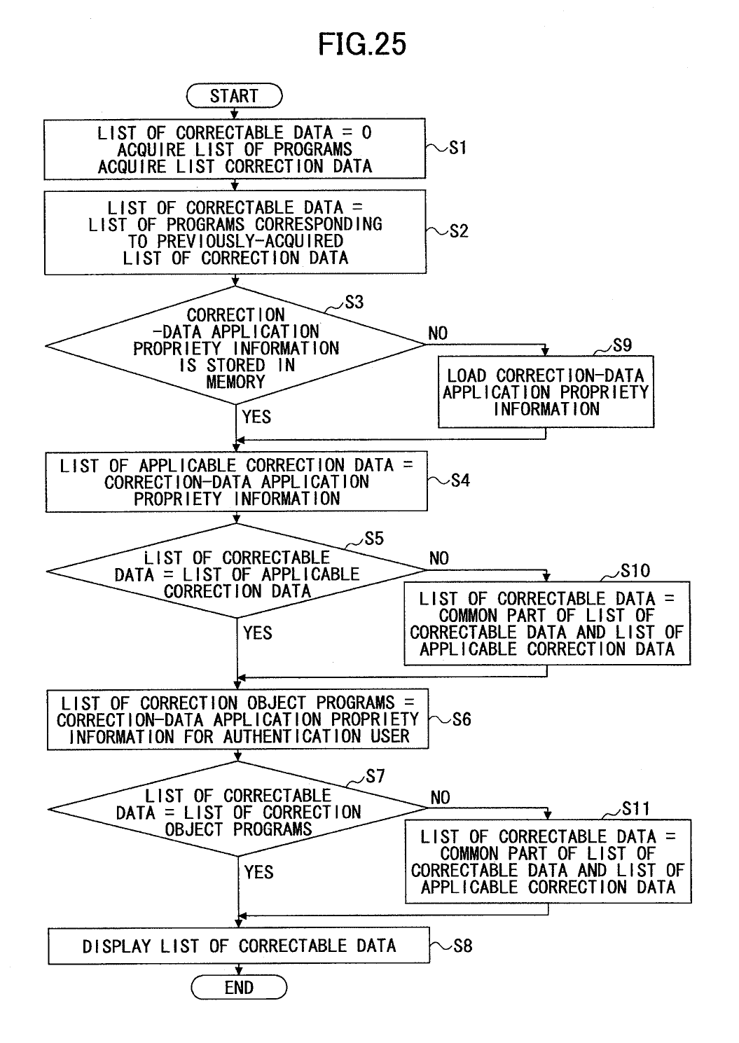

FIG. 20 is a sequence diagram showing the example of the operating sequence at the application of the correction data by the respective units of the image forming apparatuses 1 through 4 shown in FIG. 17. FIG. 25 is a flowchart showing an example of processing for verifying correction-data application propriety by the input/output control unit 11, the execution program control unit 19, and the like shown in FIG. 17.

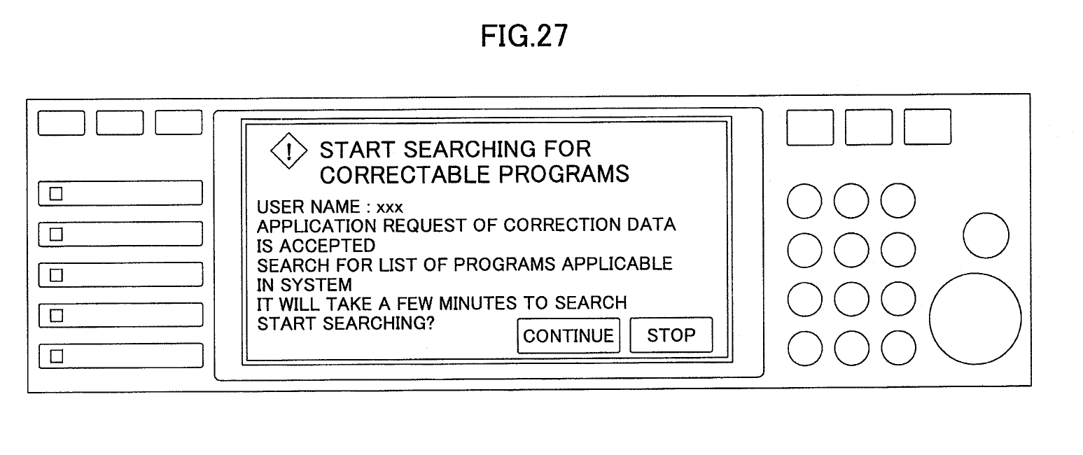

When the user performs an operation (application request of the correction data), a correctable program search screen as shown in, for example, FIG. 27, which is an operation screen for starting the search of a correctable program, is displayed on the operation panel 15. When the user selects “continue” as an indication on the correctable program search screen, an interrupt signal indicating the application request of the correction data is generated on the operation panel 15 and notified to the input/output control unit 11 as shown in, for example, FIG. 20.

Upon receiving the interrupt signal, the input/output control unit 11 makes a request to the user management unit 18 for providing a user authentication status. Then, the input/output control unit 11 acquires the user authentication status from the user management unit 18 and verifies the user authentication status.

If the user authentication status represents that authentication is successful, the input/output control unit 11 makes a request to the execution program control unit 19 for verifying the correction data application propriety.

Upon receiving the request, the execution program control unit 19 holds “a list of correctable data” indicating a list of correctable programs in the memory 23 as “0” (S1 in FIG. 25) while making a request to the input/output control unit 11 for providing a list of correction data.

Upon receiving the request from the execution program control unit 19, the input/output control unit 11 reads and acquires the list of the correction data (plural correction data) recorded in the authentication device via the external input/output interface 13 and then notifies the execution program control unit 19 of the list of the correction data.

The execution program control unit 19 acquires the list of the correction data from the input/output control unit 11 and further acquires a list of execution programs (S1 in FIG. 25). Then, in the acquired list of the execution programs, the execution program control unit 19 regards as a new “list of correctable data” (S2 in FIG. 25) the list of the execution programs (those correctable by the acquired list of the correction data) corresponding to the previously-acquired list of the correction data.

Then, the execution program control unit 19 verifies whether basic correction-data application propriety information is held in the memory 23 (S3 in FIG. 25). However, since the correction-data application propriety information is held in the memory 23, the execution program control unit 19 holds a list of programs, to which the correction data indicated by the correction-data application propriety information are applicable, in the memory 23 as “a list of applicable correction data” (S4 in FIG. 25).

Then, the execution program control unit 19 verifies whether the “list of the correctable data” and the “list of the applicable correction data” match each other (S5 in FIG. 25). Only when they do not mach each other, the execution program control unit 19 regards a common part of the lists of the respective data as a new “list of correctable data” (S10 in FIG. 25).

Then, after making a request to the input/output control unit 11 for verifying the correction-data application propriety for the authentication user, the execution program control unit 19 makes a request to the input/output control unit 11 for displaying the result of verifying the correction-data application propriety for the authentication user.

Upon receiving the request from the execution program control unit 19, the input/output control unit 11 reads correction-data application propriety information (information indicating a list of object programs to which the correction data corresponding to the authentication user are applicable) only when the correction-data application propriety information for the authentication user is stored in the storage unit 14, and holds the list of the object programs, to which the correction data corresponding to the authentication user indicated by the read correction-data application propriety information for the authentication user are applicable, in the memory 23 as “a list of correction object programs” (S6 in FIG. 25).

Then, the input/output control unit 11 verifies whether the “list of the correctable data” and the “list of the correction object programs” match each other (S7 in FIG. 25). Only when they do not match each other, the input/output control unit 11 regards a common part of the lists of the respective data as a new “list of correctable data” (S11 in FIG. 25).

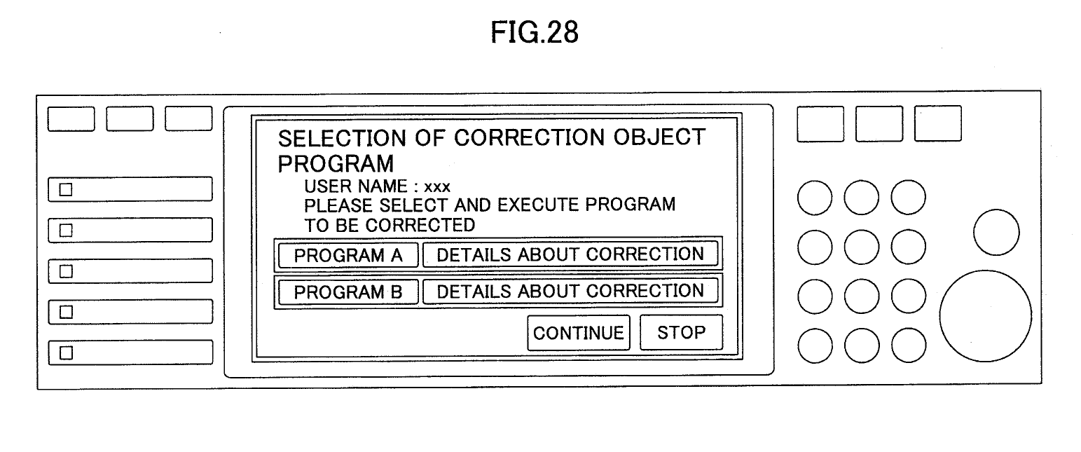

Then, upon receiving the display request of the result of verifying the correction-data application propriety for the authentication user from the execution program control unit 19, the input/output control unit 11 displays on the operation panel 15 the “list of the correctable data (correction object programs)” and a correction-object-program selection screen as an operation screen, which indicates information on the correction data capable of being applied to the list of the correctable data. A display example of the correction-object-program selection screen is shown in FIG. 28.

Here, as shown in, for example, FIG. 26C, the correction data are composed of an execution code, information on a part to which the execution code is applied, a descriptive text of the correction data, and the like. Among them, the descriptive text describes information displayed when “details about correction” as an indication on the correction-object-program selection screen shown in FIG. 28 is pressed. Further, correction object program information included in user authentication data shown in FIG. 26B together with the correction data describes information on the version of the program to which the correction data are applicable. Based on this information, the application propriety of the correction data can be determined. This determination is made so as to keep consistency with the source code of an original program for creating the correction data, and can also be made by the hash information, the creation date, and the size of a program code, and the execution code of a program change destination address, besides the information on the version.

When the user operates to select (specify) the correction object program on the correction-object-program selection screen and selects “continue” as the indication on the screen after the correction-object-program selection screen is displayed on the operation panel 15, an interrupt signal indicating a program correction request (execution request of program correction) including information on the selected correction object program is generated and notified to the input/output control unit 11. Then, the input/output control unit 11 makes a request to the execution program control unit 19 for correcting the program.

Upon receiving the request from the input/output control unit 11, the execution program control unit 19 notifies the security management unit 16 of an operation log (operation information) including the request. Accordingly, the security management unit 16 notifies the input/output control unit 11 of a security log including the notified operation log. As shown in, for example, FIG. 26E, the security log may include time information, operation object information, and correction object program information (identification information such as a program name indicating a program to which the correction data are applied).

The input/output control unit 11 writes the security log notified by the security management unit 16 in the storage unit 14.

The execution program control unit 19 makes a request to the input/output control unit 11 for providing the correction data after notifying the security management unit 16 of the operation log.

Upon receiving the request, the input/output control unit 11 reads the correction data applicable to the correction object program (capable correcting the correction object program) via the external input/output interface 13 based on the correction object program information included in the previously received program correction request, and then provides the execution program control unit 19 with the correction data.

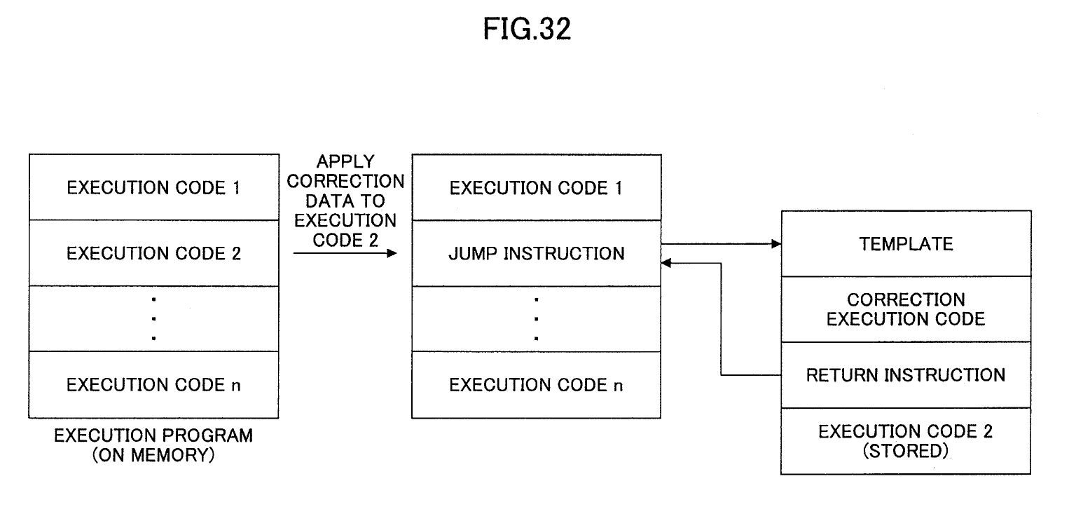

The execution program control unit 19 receives the correction data applicable to the correction object program from the input/output control unit 11, and applies the correction data to the correction object program (corrects the correction object program with the correction data). At this time, the correction object program on the memory 14 is changed in accordance with a flow as shown in, for example, FIG. 32. However, in order to rewrite an execution code, the execution of the correction object program is suspended. Specifically, the execution of other processes is suspended by a process having the highest priority, and the change of the execution code and the cancellation of the suspension are performed by the process having the highest priority.

When the correction data are applied to the correction object program, the execution program control unit 19 makes a request to the input/output control unit 11 for displaying the application status of the correction data so as to notify the user of a situation where the correction data are applied to the correction object program.

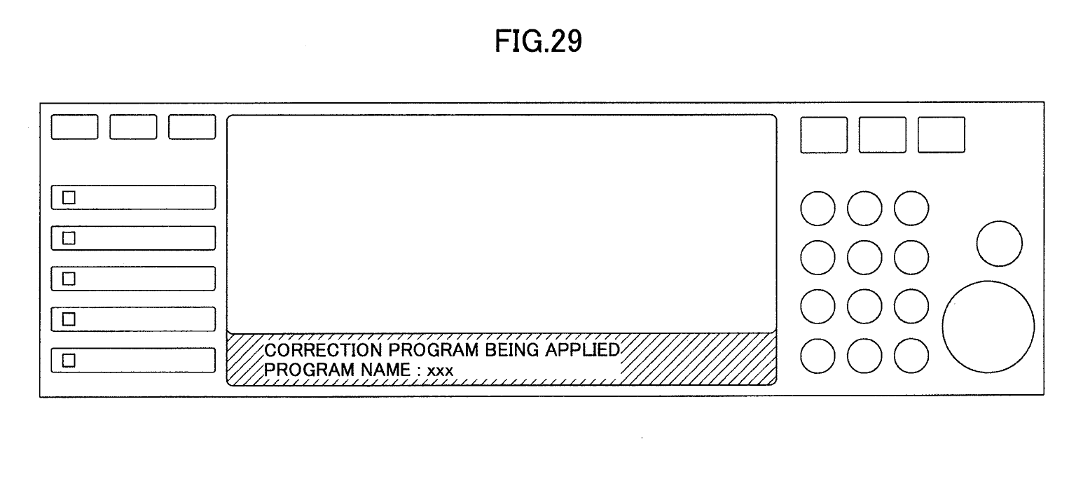

Upon receiving the request, the input/output control unit 11 displays on the operation panel 15 a screen, which indicates that the correction data including the information on the correction object program are being applied. A display example of the screen is shown in FIG. 29. Thus, the user can find the execution status of the correction data and briefly recognize the situation of the system together with the details of the correction.

### Second Reference Example

Next, a description is given of a second reference example of the present invention. Note that since the second reference example is only slightly different from the first reference example, the figures used to describe the first reference example are used again.

The second reference example describes the application of correction data in the plural image forming apparatuses 1 through 3 connected to one another via a network. Note that descriptions of parts the same as those of the first reference example are omitted.

In the second reference example, basic operations are the same as those of the first reference example, but the user is allowed to apply the correction data to plural image forming apparatuses (here the “image forming apparatuses 2 and 3”) with a single image forming apparatus (here the “image forming apparatus 1”). Thus, it is possible to remove the burden of applying the correction data.

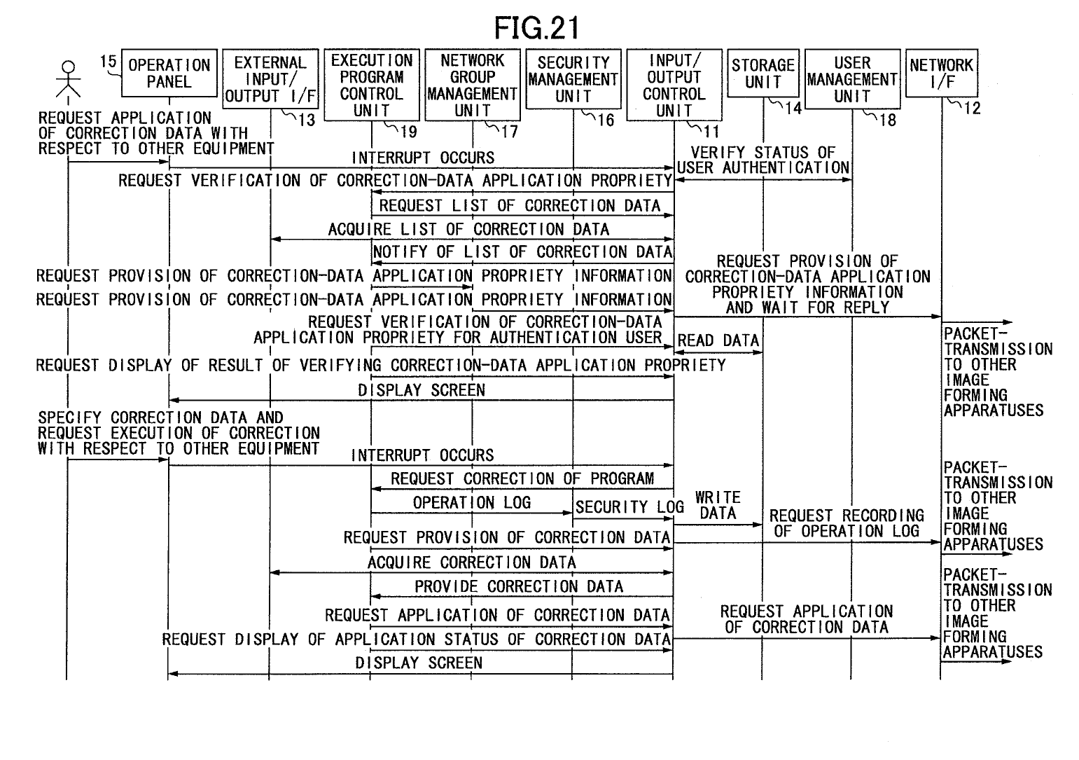

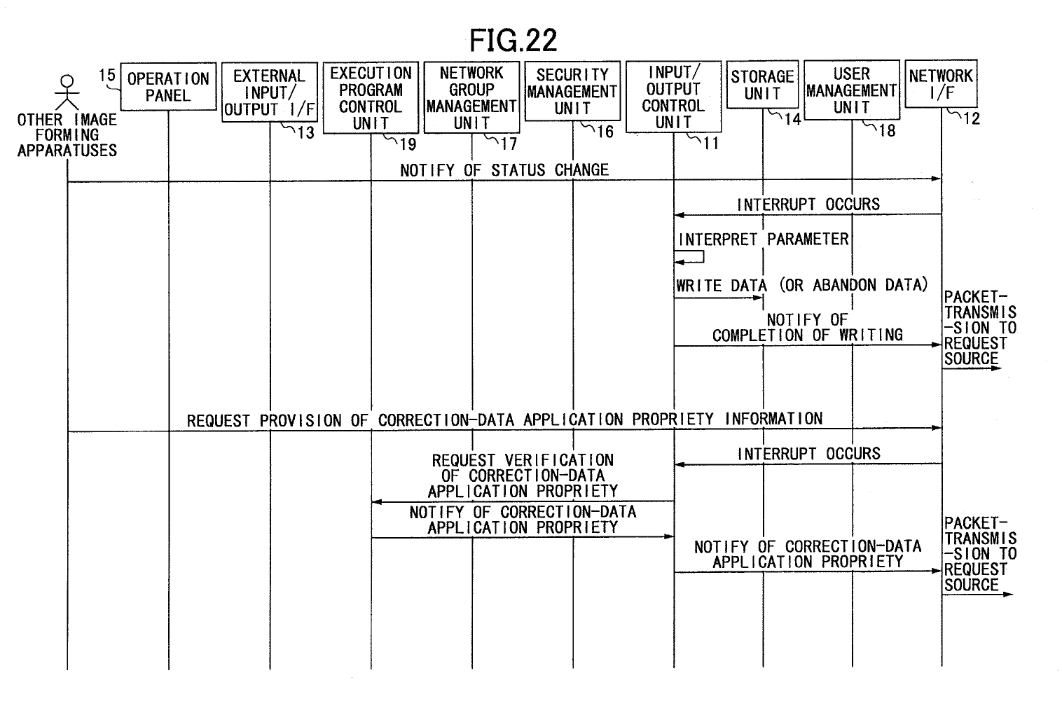

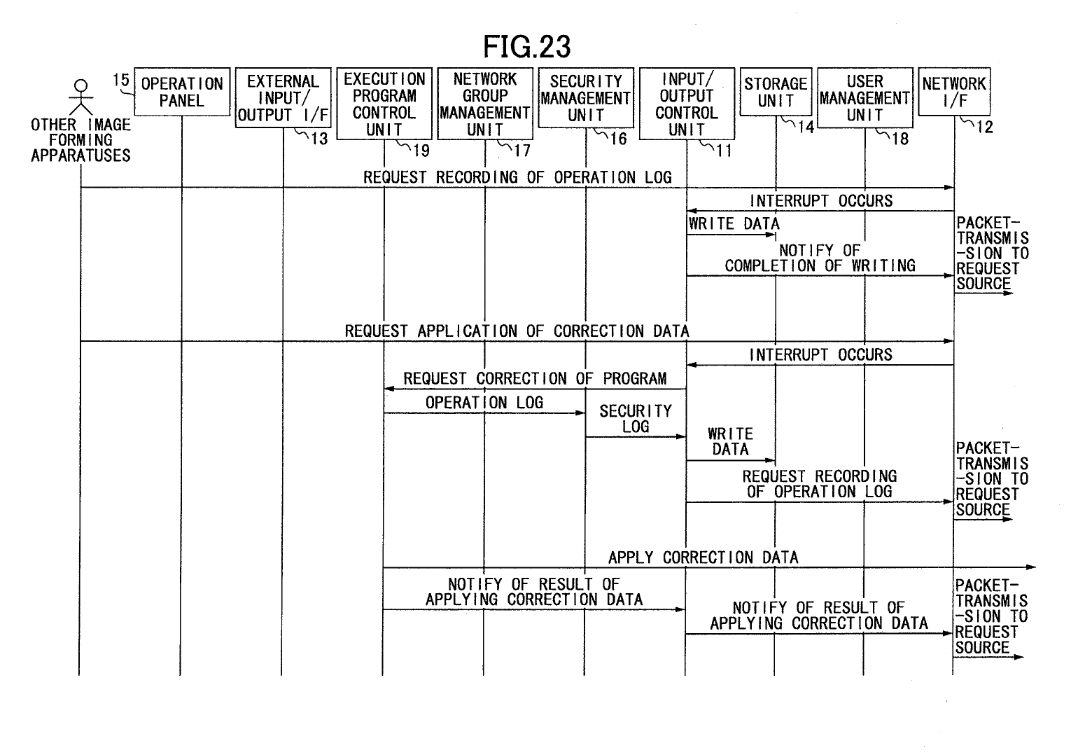

FIG. 21 is a sequence diagram showing another example of an operating sequence at the application of the correction data by the respective units of the image forming apparatuses 1 through 4 shown in FIG. 17. FIG. 22 is a sequence diagram showing an example of an operating sequence at the notification of a status change from the external equipment. FIG. 23 is a sequence diagram showing an example of an operating sequence at the application of the correction data from the external equipment.

As shown in FIG. 17, the image forming apparatus 1 has the network group management unit 17 as a module for managing the network. The network group management unit 17 is the module that recognizes the image forming apparatuses 2 and 3 to which the correction data are applicable. Accordingly, when the user wants to apply the correction data, he or she is allowed to automatically select the image forming apparatuses 2 and 3 to which the correction data are applicable among those connected to the network.

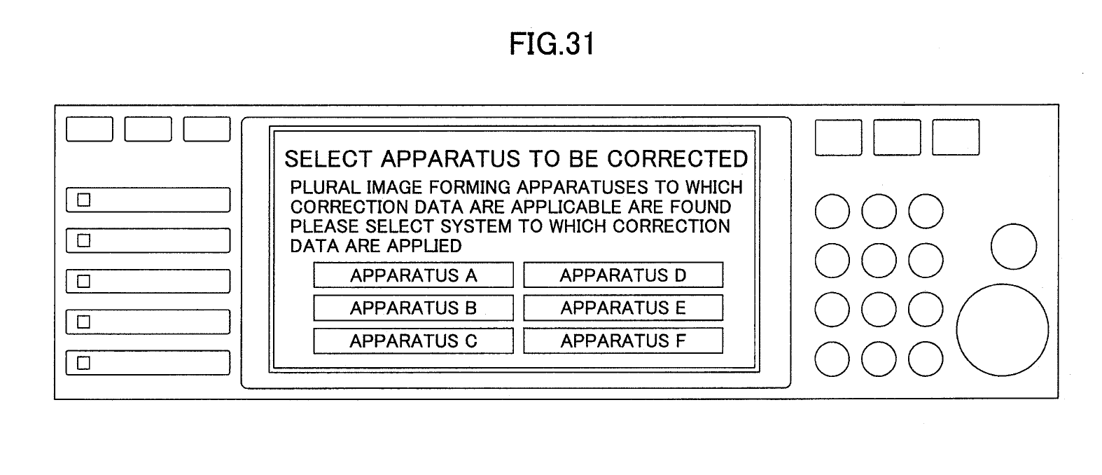

The user operates to display the correctable program search screen as shown in, for example, FIG. 27 on the operation panel 15 and then selects “continue” as the indication on the correctable program search screen. The image forming apparatuses 1 through 3, to which the correction data held in an authentication device such as the USB memory 33 connected to the external input/output interface 13 are applicable, are connected to the network. Therefore, although omitted in FIG. 21, the input/output control unit 11 of the image forming apparatus 1 acquires apparatus information on the image forming apparatuses 1 through 3 from the network group management unit 17 and displays on the operation panel 15 a correction-object-apparatus selection screen as an operation screen showing a list of the image forming apparatuses 1 through 3. An example of the correction-object-apparatus selection screen is shown in FIG. 31. However, since the image forming apparatuses 1 through 3 correspond to “apparatuses A through C,” “apparatuses D through F” among those shown in FIG. 31 are not actually displayed.

When the user operates to select the correction object apparatus on the correction-object-apparatus selection screen, an interrupt signal indicating the application request of the correction data is generated on the operation panel 15 and notified to the input/output control unit 11 as shown, for example, in FIG. 21.

Upon receiving the interrupt signal, the input/output control unit 11 makes a request to the user management unit 18 for providing a user authentication status. Then, the input/output control unit 11 acquires the user authentication status from the user management unit 18 and verifies the user authentication status. If the user authentication status represents that authentication is successful, the input/output control unit 11 makes a request to the execution program control unit 19 for verifying correction data application propriety.

Upon receiving the request, the execution program control unit 19 makes a request to the input/output control unit 11 for providing a list of correction data. Thus, like the first reference example, the execution program control unit 19 acquires the list of the correction data from the input/output control unit 11 and further acquires a list of execution programs (S1 in FIG. 25). Then, in the acquired list of the execution programs, the execution program control unit 19 regards as a new “list of correctable data” the list of the execution programs corresponding to the previously acquired list of the correction data (S2 in FIG. 25).

Then, the execution program control unit 19 verifies whether basic correction-data application propriety information is held in the memory 23 (S3 in FIG. 25). However, if a previously selected correction object apparatus is only the image forming apparatus 1, the same operations as those of the first reference example are performed. On the other hand, if the correction object apparatuses are only the image forming apparatuses 2 and 3, the basic-correction-data application propriety information is not recorded in the memory 23. Therefore, processing for acquiring the correction-data application propriety information from the image forming apparatuses 2 and 3 is performed. The following describes operations where the correction object apparatuses are only the image forming apparatuses 2 and 3. However, if the correction object apparatuses are the image forming apparatuses 1, 2, and 3, the following operations may be added to the same operations as those of the first reference example.

In order to acquire the basic correction-data application propriety information, the execution program control unit 19 loads the correction-data application propriety information from the image forming apparatuses 1 and 2 with the network group management unit 17 and the like (S9 in FIG. 25).

That is, the execution program control unit 19 first makes a request to the network group management unit 17 that handles the image forming apparatuses 1 and 2 for providing the basic-correction-data application propriety information.

Upon receiving the request from the execution program control unit 19, the network group management unit 17 notifies the input/output control unit 11 of the request together with apparatus information (such as IP addresses) indicating the other image forming apparatuses 2 and 3 in the same group.

The input/output control unit 11 receives the request together with the apparatus information from the network group management unit 17 and notifies the network interface 12 of these information. Then, the input/output control unit 11 waits for a reply from the network interface 12.

Upon receiving the request from the input/output control unit 11 together with the apparatus information, the network interface 12 packet-transmits the request to the other image forming apparatuses 2 and 3 via the network based on the apparatus information and notifies (replies) the input/output control unit 11 of the result of the transmission.

Then, after acquiring the basic-correction-data application propriety information packet-transmitted from the other image forming apparatuses 2 and 3 via the network interface 12 and the input/output control unit 11, the execution program control unit 19 holds a list of programs, to which correction data indicated by the acquired correction-data application propriety information are applicable, in the memory 23 as a “list of applicable correction data” (S4 in FIG. 25).

Then, by performing the same operations as those of the first reference example, the input/output control unit 11 can display on the operation panel 15 the correction-object-program selection screen as shown in FIG. 28.

When the user operates to select (specify) the correction object program on the correction-object-program selection screen and selects “continue” as the indication on the screen, an interrupt signal indicating a program correction request (a request for executing program correction) including information on the selected correction object program is generated and notified to the input/output control unit 11. Then, the input/output control unit 11 makes a request to the execution program control unit 19 for correcting the program.

Upon receiving the request from the input/output control unit 11, the execution program control unit 19 notifies the security management unit 16 of an operation log (operation information) including the request. Accordingly, the security management unit 16 notifies the input/output control unit 11 of a security log including the notified operation log.

After writing the security log notified by the security management unit 16 in the storage unit 14, the input/output control unit 11 notifies the network interface 12 of the recording request of the operation log including the operation log in the security log together with the previously received apparatus information.

Upon receiving the recording request of the operation log from the input/output control unit 11 together with the apparatus information, the network interface 12 packet-transmits the recording request to the other image forming apparatuses 2 and 3 via the network based on the apparatus information.

The execution program control unit 19 makes a request to the input/output control unit 11 for providing the correction data after notifying the security management unit 16 of the operation log.

Upon receiving the request, the input/output control unit 11 reads the correction data applicable to the correction object program via the external input/output interface 13 based on information indicating the correction object program information included in the previously received program correction request, and then provides the execution program control unit 19 with the correction data.

The execution program control unit 19 receives the correction data applicable to the selected correction object program from the input/output control unit 11, and makes a request to the input/output control unit 11 for applying correction data including the correction data and the information indicating the correction object program so as to apply the correction data to the correction object programs.

The input/output control unit 11 notifies the network interface 12 of the application request of the correction data notified by the execution program control unit 19 together with the previously received apparatus information.

Upon receiving the application request of the correction data from the input/output control unit 11 together with the apparatus information, the network interface 12 packet-transmits the application request of the correction data to the other image forming apparatuses 2 and 3 via the network based on the apparatus information.

After notifying the input/output control unit 11 of the application request of the correction data including the correction data and the information indicating the correction object program (correction object program information), the execution program control unit 19 makes a request to the input/output control unit 11 for displaying the application status of the correction data so as to notify the user of a situation where the correction data are being applied.

Upon receiving the display request of the application status of the correction data, the input/output control unit 11 displays on the operation panel 15, which indicates that the correction data including the information on the correction object program are being applied.

Note that an access to the network is made in a case where the correction object program information of the user is transmitted, in a case where the user operates to make a request of applying the correction data, in a case where the correction object program information of the respective image forming apparatuses is acquired, and in a case where the correction data are applied, when the authentication information (user information) is determined as described above. The protocol of the network may be an arbitrary one but is required to sufficiently ensure security on the network.

On the other hand, as shown in, for example, FIG. 22, when status change information is transmitted from the image forming apparatus 1 as external equipment to the image forming apparatuses 2 and 3 via the network, the network interface 12 receives the status change information and notifies the input/output control unit 11 of an interrupt signal including the status change information.

After receiving the interrupt signal, the input/output control unit 11 interprets the status change information (parameter) included in the interrupt signal, determines a list of object programs to which correction data corresponding to an authentication user are applicable, and writes and stores the list of the object programs in the storage unit 14 as correction-data application propriety information (parameter) for the authentication user indicating the information.

Upon completing the writing, the input/output control unit 11 notifies the network interface 2 of the fact.

Upon receiving the notification that the writing of the correction-data application propriety information for the authentication user has been completed, the network interface 12 packet-transmits data indicating information on the notification to the image forming apparatus 1 as the transmission source of the status change information.

Note that in a case where previously interpreted status change information indicates the deletion request (to be described below) of the correction-data application propriety information for the authentication user, the network interface 12 deletes the correction-data application propriety information from the storage unit 14.

Further, when the provision request of basic correction-data application propriety information is transmitted from the image forming apparatus 1 via the network, the network interface 12 receives it and notifies the input/output control unit 11 of an interrupt signal including the provision request of the correction-data application propriety information.

Upon receiving the interrupt signal, the input/output control signal 11 makes a request to the execution program control unit 19 for verifying the basic correction-data application propriety information in response to the provision request of the correction-data application propriety information.

Upon receiving the verification request of the basic correction-data application propriety information from the input/output control unit 11, the execution program control unit 19 notifies the input/output control unit 11 of the basic correction-data application propriety information held in the memory 23.

The input/output control unit 11 receives the correction-data application propriety information and notifies the network interface 12 of the same.

Upon receiving the basic correction-data application propriety information, the network interface 12 packet-transmits the correction-data application propriety information to the image forming apparatus 1 as a provision request source.

On the other hand, as shown in, for example, FIG. 23, when the recording request of an operation log is transmitted from the image forming apparatus 1 as external equipment to the image forming apparatuses 2 and 3 via the network, the network interface 12 receives the recording request and notifies the input/output control unit 11 of an interrupt signal including the recording request.

After receiving the interrupt signal, the input/output control unit 11 writes and stores the operation log included in the recording request in the storage unit 14 as data.

Upon completing the writing, the input/output control unit 11 notifies the network interface 2 of the fact.

Upon receiving the notification that the writing of the operation log has been completed, the network interface 12 packet-transmits data indicating information on the notification to the transmission source of the status change information.

Further, when the application request of correction data is transmitted from the image forming apparatus 1 via the network, the network interface 12 receives the application request and notifies the input/output control unit 11 of an interrupt signal including the application request of the correction data.

Upon receiving the interrupt signal, the input/output control signal 11 makes a request (program correction request) to the execution program control unit 19 for applying the correction data in response to the application request of the correction data included in the interrupt signal.

Upon receiving the application request of the correction data from the input/output control unit 11, the execution program control unit 19 notifies the security management unit 16 of an operation log including the application request. Accordingly, the security management unit 16 notifies the input/output control unit 11 of a security log including the notified operation log.

After writing the security log notified by the security management unit 16 in the storage unit 14, the input/output control unit 11 makes a request to the network interface 12 for recording the operation log including the operation log in the security log.

Upon receiving the recording request of the operation log from the input/output control unit 11, the network interface 12 packet-transmits the recording request to the application request source of the correction data.

After notifying the security management unit 16 of the operation log including the application request of the correction data, the execution program control unit 19 applies the correction data included in the application request to the correction object program indicated by the correction object program information included in the application request (corrects the correction object program with the correction data).

Upon completing the application of the correction data, the execution program control unit 19 notifies the input/output control unit 11 of an application result.

Upon receiving the application result of the correction data from the execution program control unit 19, the input/output control unit 11 notifies the network interface 12 of the application result.

Upon receiving the application result of the correction data, the network interface packet-transmits the application result to the application request source of the correction data.

In the first and second reference examples, the security log including the operation log as shown in FIG. 26E is recorded so as to eliminate the user's concern about the application of the correction data. Here, a description is given of the security log in further detail.

As matters to be notified to the user, consideration is given to operations relating to correction data, times at which the operations are executed, the execution results of the operations, and operation objects.

In applying correction data to a single image forming apparatus, it is only required that the security log be stored in a storage unit such as a HDD provided in the image forming apparatus every time an operation is executed. On the other hand, in a case where an image forming apparatus is connected to plural networks, when it is assumed that an image forming apparatus to be operated by the user is a host and other image forming apparatuses to which correction data are applied are clients, security information is exchanged between these image forming apparatuses.

The exchange of the security information represents that the application of the correction data is shared between the clients and the host. This is because since information on the application of the correction data is notified to an operator, the host collects information within a range in which it is handled by all the network group management units 17. Further, it is also presumed that the information is written in a paper or notified to the management system of an image forming apparatus connected to a network. Accordingly, it is possible for the user to collectively manage information on the propriety of the correction data, and it is also possible to notify the user of information in a modified state in such a manner as to be easily confirmed by the user compared with screen information.

### Third Reference Example

Next, a description is given of a third reference example of the present invention. Note that since the third reference example is only slightly different from the first reference example or the second reference example, the figures used to describe the first reference example are used again.

The third reference example describes the behavior of the system when the user removes an authentication device. Note that descriptions of parts the same as those of the first and second reference examples are omitted.

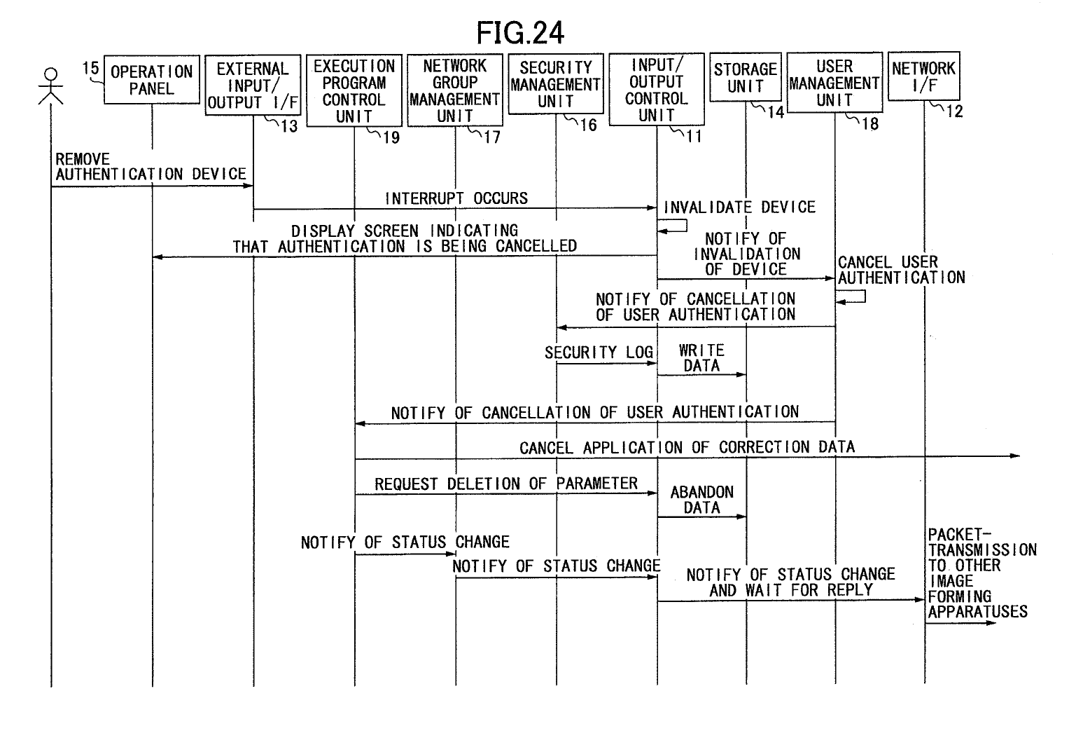

FIG. 24 is a sequence diagram showing an example of an operating sequence at the cancellation of user authentication by the respective parts of the image forming apparatuses 1 through 4 shown in FIG. 17.

The user may remove the authentication device from the image forming apparatus at any timing. Therefore, after the external input/output interface 13 detects that the authentication device has been removed, the system (including a network destination) is required to be restored to its initial status. The status of the system is managed by the execution program control unit 19 of each of the image forming apparatuses. Therefore, in the image forming apparatus as a user operating source, the cancellation of correction data is first notified to the user.

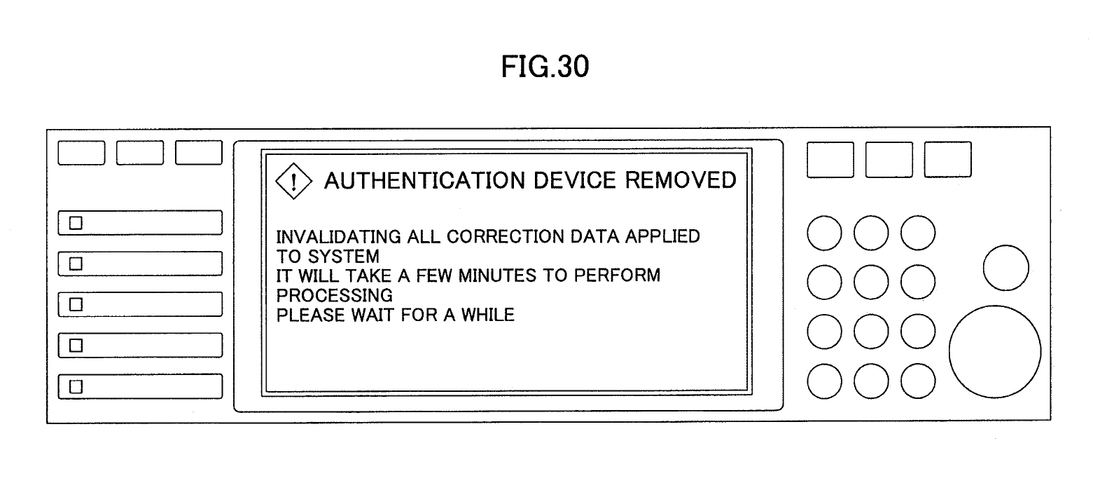

That is, when the authentication device is removed, the external input/output interface 13 detects the removal of the authentication device. Then, as shown in, for example, FIG. 24, the external input/output interface 13 generates an interrupt signal indicating the removal of the authentication device and notifies the input/output control unit 11 of the interrupt signal. Accordingly, the input/output control unit 11 invalidates the authentication device, displays on the operation panel 15 an authentication cancellation screen indicating the cancellation of the authentication (invalidation of the correction data) as shown in, for example, FIG. 30, and notifies the user management unit 18 of the invalidation of the authentication device.

Upon receiving the notification, the user management unit 18 abandons user authentication data in the memory 23 to cancel the user authentication, and notifies the security management unit 16 of the fact.

Upon receiving the notification of the cancellation of the user authentication from the user management unit 18, the security management unit 16 notifies the input/output control unit 11 of a security log including an operation log indicating the cancellation of the user authentication.

The input/output control unit 11 writes the security log notified by the security management unit 16 in the storage unit 14.

After notifying the security management unit 16 of the cancellation of the user authentication, the user management unit 18 also notifies the execution program control unit 19 of the cancellation of the user authentication.

Upon receiving the notification of the cancellation of the user authentication from the user management unit 18, the execution program control unit 19 cancels the application of the correction data (cancels the correction of a correction object program with the correction data).

Then, the execution program control unit 19 makes a request to the input/output control unit 11 for deleting correction-data application propriety information (parameter) for the authentication user. Thus, the input/output control unit 11 deletes the correction-data application propriety information for the authentication user held in the storage unit 14 shown in FIG. 17 (data abandonment).

After making a request to the input/output control unit 11 for deleting the correction-data application propriety information for the authentication user, the execution program control unit 19 notifies the network group management unit 17 of information indicating the deletion of the correction-data application propriety information as status change information.

Upon receiving the status change information, the network group management unit 17 notifies the input/output control unit 11 of the status change information.

Upon receiving the status change information, the input/output control unit 11 notifies the network interface 12 of the status change information together with previously received apparatus information, and waits for a reply from the network interface 12.

Upon receiving the status change information from the input/output control unit 11 together with the apparatus information, the network interface 12 packet-transmits the status change information to the other image forming apparatuses in the same group via the network based on the apparatus information and notifies (replies) the input/output control unit 11 of a transmission result. With the packet-transmission of the status change information, it is possible to make a request to the other image forming apparatuses in the same group for deleting (removing) the correction-data application propriety information for the authentication user.

A description is collectively given of the functions and effects of the above respective reference examples in the following items (1) through (6).

(1) The image forming apparatus (equipment) has the network I/F communicably connected to the server machine and the external input/output I/F communicably connected to an external recording medium such as a USB memory detachable from the image forming apparatus. The image forming apparatus determines whether it is possible to correct an object program (correction propriety) requested by the user based on user authentication information recorded in the external recording medium. If it is possible to correct the correction object program, the image forming apparatus acquires correction data (correction program) for correcting the correction object program and applies the correction data to the correction object program (corrects the correction object program with the correction data).

That is, if user authentication with respect to firmware is performed every time the firmware is changed, for example, when the firmware is changed according to the function of dynamically correcting the program, the behavior of the system may be affected just like the case of degradation in the performance of a system or the like. Therefore, when it is desired to perform an inspection using correction with respect to the equipment, it is not possible to grasp problems residing in the equipment accurately. Accordingly, once user authentication and the correction object program are specified using the external recording medium, the operations of the program are not authenticated, which does not adversely affect the behavior of the system. That is, when the user benefits from the technology of dynamically changing the program, he/she can ensure minimum security, prevent degradation in processing performance of the program, and improve the convenience of the user with respect to the equipment at the same time.

(2) If the image forming apparatus further has the function of notifying the other image forming apparatuses of the fact that the user authentication is being made and the user authentication is applied within an allowable communication range, it is possible to correct the program without making the user authentication again.

That is, it is often that the correction of the correction object program is not made only in equipment having performed the user authentication. In this case, if an authentication range by a detachable external recording medium such as a USB memory is applied only to the equipment, it is required to remove the external recording medium (cancel the authentication) and perform the authentication again with respect to the object equipment so as to cause the other equipment to perform the same correction. Accordingly, if the image forming apparatus has a protocol for exchanging information with the other equipment even in a limited network range, it is possible to make program correction in the plural image forming apparatuses once the authentication is made with respect to any equipment.

(3) The image forming apparatus further has the function of holding (recording) an operation log (operation information) indicating the history of an operation when the predetermined operation is performed, and outputs the held operation log according to a predetermined method.

That is, there is a case that the user is concerned about what processing is performed in dynamically correcting the program. Accordingly, the image forming apparatus causes the user to record a main operation log at the application of correction data and perform an operation on an operation panel or the like to output (print or display) the operation log, thereby making it possible to eliminate the user's concern.

(4) The application propriety of correction data is determined based on correction-data application propriety information stored in a predetermined storage unit.

That is, if the correction data are randomly applied, there may be a case that the system does not operate (due to a security threat caused by rewriting of the program). Accordingly, a determination criterion (correction-data application propriety information) for determining the application propriety of the correction data is previously set, and the application propriety of the correction data is determined based on the determination criterion. Thus, availability as the system is protected. Further, the applicable range of the correction data can be controlled for each of the equipment. Therefore, it is also possible to control operations in accordance with the security levels of the image forming apparatuses on the network in which the plural image forming apparatuses are provided.

(5) The user specifies user authentication information to be used and the range of a program to be corrected, and the correction range of the program is specified by the authentication information. Thus, in order to protect the operations of the system, the correction program capable of being operated by the user at the generation of the authentication information is specified.

(6) The application statuses of correction data are notified. That is, there is a case that the user is concerned about operating statuses inside the system when the program is dynamically corrected. Therefore, displaying the application statuses and execution statuses of the correction data makes it is possible to eliminate the user's concern. Further, since the apparatus being operated by the user can be recognized, it is possible to display the operating statuses of correction data applied to the other apparatuses on a user's operating source.

Meanwhile, in an electronic equipment management system capable of changing the software configuration of electronic equipment including an information processing apparatus such as an image forming apparatus in accordance with a request by a management apparatus, the correction of the program as in the above respective reference examples corresponds to an unintended change in software configuration by a subject other than the management apparatus. However, there has been a problem in that the management apparatus cannot detect and recover the change.

Accordingly, in order to solve the problem, the following embodiment has, features (A) through (G) in detecting and recovering a change when the unintended change in software configuration is made by a subject other than a management apparatus.

(A) Periodically acquire software information introduced into an information processing apparatus.

(B) Compare the acquired software information with software information in a storage unit to detect a difference between them.

(C) If the difference is detected, the detection of a change in software configuration is notified to the user via a management center.

(D) Update the software information in the storage unit with the acquired software information.

(E) Detect a request for changing the software configuration by the user via the management center.

(F) Making a request to the information processing apparatus for changing the software configuration using license information in the storage unit.

(G) Notify the user of a request result via the management center.

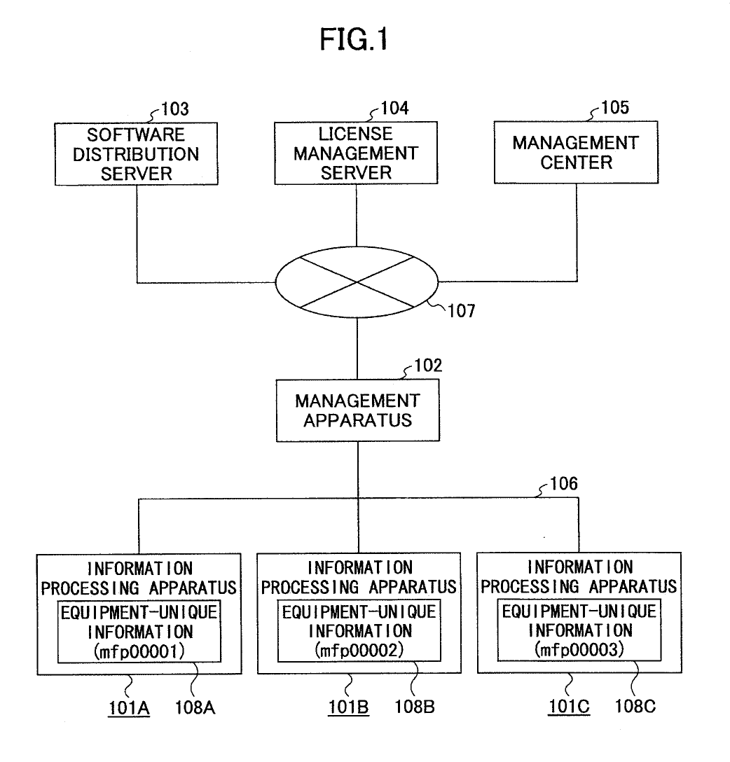

Next, a description is given of the respective features in detail with reference to FIGS. 1 through 15.

(Network Configuration Example of Information Processing Apparatus Management System)

First, a description is given of the general outline of an information processing apparatus management system as an embodiment of an electronic equipment management system including a management apparatus according to the present invention.

FIG. 1 is a conceptual diagram showing a network configuration example of the information processing apparatus management system.

The information processing apparatus management system is composed of information processing apparatuses 101 (101A, 101B, and 101C), a management apparatus 102, a software distribution server 103, a license management server 104, and a management center 105. Here, although the number of the information processing apparatuses 101 is three, it is just an example. That is, the number of the information processing apparatuses 101 may be arbitrarily, provided that it is one or more.

The information processing apparatuses 101 and the management apparatus 102 are communicably connected to each other via a local area network 106 such as a LAN.

The management apparatus 102, the software distribution server 103, the license management server 104, and the management center 105 are communicably connected to one another via the Internet 107.

The information processing apparatuses 101 (101A, 101B, and 101C) are image reading apparatuses (scanners or the like), image forming apparatuses (digital multifunction peripherals, digital copiers, facsimile machines, printers, or the like), PCs (personal computers), in-vehicle information processing apparatuses, or the like, and hold equipment-unique information items 108 (108A, 108B, and 108C). The equipment-unique information items 108 are unique (specific) information items such as equipment identification numbers, and thus are not made the same between the different information processing apparatuses 101. Here, the respective equipment-unique information items 108 are indicated as mfp00001, mfp00002, and mfp00003.

The management apparatus 102 performs the management of the information processing apparatuses 101. For example, the management apparatus 102 performs the acquisition of information on software introduced into the information processing apparatuses, requesting for the addition, update, deletion, activation, deactivation, or the like of the software, or the like. Further, the management apparatus 102 performs the download of software or the like from the software distribution server 103 and the issuance, return, or the like of licenses from/to the license management server 104. Moreover, the management apparatus 102 performs the notification of information on the information processing apparatuses 101 managed by the management apparatus 102 or the like to the management center 105.

The software distribution server 103 distributes software to the management apparatus 102.

The license management server 104 performs the management of licenses so that specific programs (software) such as firmware and plug-ins are used by the information processing apparatuses 101.

The management center 105 has a central management unit that collects notifications transmitted from the information processing apparatuses used by the users via the management apparatus 102 and manages the information processing apparatuses 101. The management center 105 intervenes in exchanges such as requests and verifications between the users using the information processing apparatuses 101 and the management apparatus 102.

### (Hardware Configuration Example of Management Apparatus)

Next, a description is given of a hardware configuration example of the management apparatus 102 shown in FIG. 1.

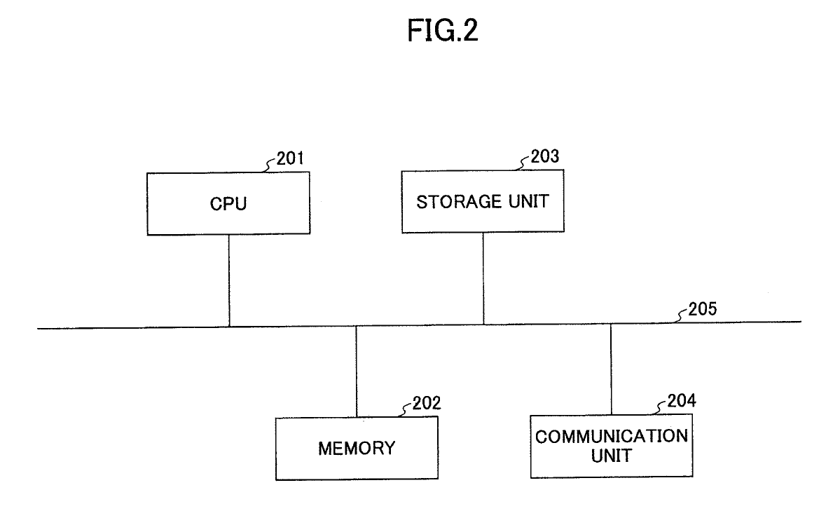

FIG. 2 is a block diagram showing the hardware configuration example of the management apparatus 102.

The management apparatus 102 is composed of a CPU 201, a memory 202, a storage unit 203, and a communication unit 204, all of which are connected to one another via a bus 205.

The CPU 201 controls the entire processing of the management apparatus 102 and performs various calculation processing while accessing the memory 202, the storage unit 203, and the communication unit 204. By executing a predetermined program on the memory 202 and controlling the communication unit 204, the CPU 201 can realize the functions of an information acquisition unit, a difference detection unit, a change-detection notification unit, an information update unit, a request detection unit, a change request unit, a request-result notification unit, a license file request unit, a license file acquisition unit, a license return request unit, a product-key read unit, a time acquisition unit, a comparison unit, and an information deletion unit, all of which are related to the present invention.

The memory 202 is a storage unit such as a RAM having a temporary storage area, which reads the program executed by the CPU 201 from the storage unit and develops the program and holds data temporarily required when the CPU 201 performs the various calculation processing.

The storage unit 203 is a non-volatile storage unit such as a HDD having a permanent storage area, which holds various programs and data constituting software.

The communication unit 204 is a connection unit (communication unit) communicably connected to other electronic equipment via a network to perform communications.

Note that since the information processing apparatuses 101, the software distribution server 103, and the license management server 104 have a hardware configuration similar to that of the management apparatus 102, their diagrammatic representations and descriptions are omitted. Further, the information processing apparatuses 101 can realize the functions of a connection unit, a storage unit, an equipment-unique-information notification unit, an equipment-unique-information determination unit, and an activation processing unit, all of which are related to the present invention. Further, the software distribution server 103 can realize the functions of a connection unit, a storage unit, a license file issuance unit, and a license return unit, all of which are related to the present invention.

(Example of Software Information Acquirable from Information Processing Apparatuses)

Next, a description is given of an example of software information acquirable from the information processing apparatuses 101 shown in FIG. 1.

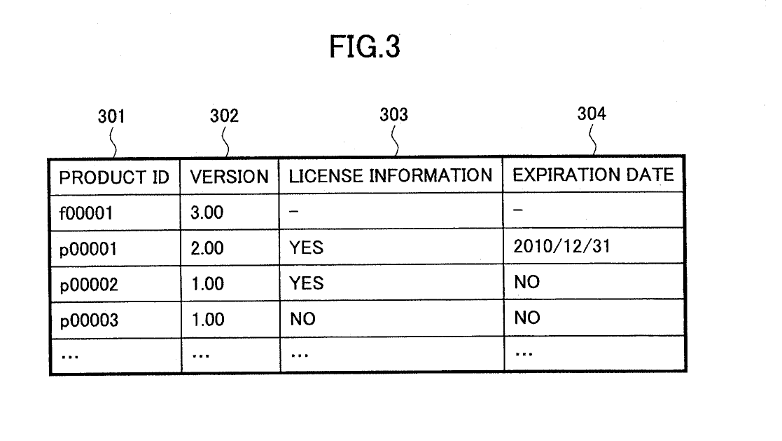

FIG. 3 is an explanatory diagram showing the example of the software information.

The software information acquirable from the information processing apparatuses 101 are classified into two information, i.e., firmware information and plug-in information.

The firmware information is composed of a product ID 301 and a version 302. Here, firmware whose product ID 301 is “f00001” exists.

The plug-in information is composed of the product ID 301, the version 302, license information 303, and an expiration date 304. Here, plug-ins whose product IDs are “p00001,” “p00002,” and “p00003,” respectively, exist.

Although there are the one firmware and the three plug-ins here, the number of the firmware and the plug-ins are arbitrarily. Further, software information other than the software (programs) may be added.

The product ID 301 is an identifier (identification information) associated with the software one-on-one.

The version 302 is a number related to the release of the software. The larger the number is, the more recently the software is released.

The license information 303 represents whether the corresponding plug-in holds a license (“YES” or “NO”). In the case of “YES,” it represents that the corresponding plug-in has the license and thus is available. In the case of “NO,” it represents that the corresponding plug-in does not have the license and thus is not available. Since the firmware is software that performs a basic control on hardware, it is irrelevant to the presence or absence of a license and available at all times.

The expiration date 304 represents when the license of the corresponding plug-in expires.

For example, if the license information 303 is “YES” and the expiration date 304 is “2010 Dec. 31,” it represents that the license of the corresponding plug-in is valid until 2010 Dec. 31. After the expiration date 2010 Dec. 31, the license information 303 of the corresponding plug-in is changed from “YES” to “NO” and the expiration date 304 thereof is changed from 2010 Dec. 31 to “N/A.”

If the license information 303 is “YES” and the expiration date 304 is “N/A,” it represents that the corresponding license is valid indefinitely.

If the license information 303 is “NO,” the corresponding plug-in does not have the license and thus the expiration date 304 is “N/A.”

Note that it is also possible to add the license information and the expiration date to the firmware information.

The management apparatus 102 stores the software information on the respective information processing apparatuses 101 in the storage unit 203.

(Example of License Management Information Held by License Management Server)

Next, a description is given of an example of license management information held by the license management server 104 shown in FIG. 1.

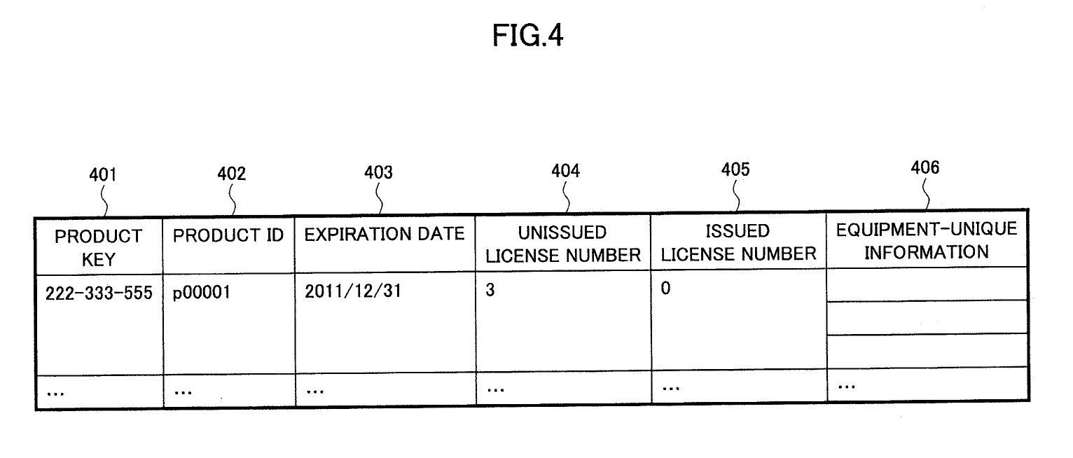

FIG. 4 is an explanatory diagram showing the example of the license management information.

Some data held by the license management server 104 include the license management information. The license management information is composed of a product key 401, a product ID 402, an expiration date 403, an unissued license number 404, an issued license number 405, and an equipment-unique information 406.

The product key 401 is a key required when the user receives the issuance of a license. By receiving the issuance of the license with the product key 401, the user can use software. Here, it is assumed that the user has purchased a license from a software distribution source and the product key “222-333-555” has been issued and registered in the license management server 104.

The product ID 402 is an identifier associated with software one-on-one. Here, the software available with the product key 401 is shown. That is, the software whose product key 401 is “222-333-555” and product key 401 is “p00001” is available.

The expiration date 403 represents when the license issued by the product key 401 expires.

The unissued license number 404 represents the upper limit of the number of the information processing apparatuses 101 that can use the software with the product key 401. Here, since the unissued license number is “3,” the three information processing apparatuses 101 at maximum can use the software with the product key 401 “222-333-555.”

The issued license number 405 represents the number of the information processing apparatuses 101 that are currently using the software with the product key 401. Here, since the issued license number is “0,” none of the information processing apparatuses is using the software with the product key 401 “222-333-555.”

The equipment-unique information 406 represents equipment-unique information on the information processing apparatus that is using the software with the product key 401. That is, if the product key 401 is the same, the issued license number 405 and the equipment-unique information 406 match each other. Here, since the issued license number 405 is “0,” nothing appears in the equipment-unique information 406.

The configuration of the license management information is an example, and information other than the above information may be added. For example, if there are plural license contract modes, information on the plural license contract modes may be added.

(Example of License File Issued by License Management Server)

Next, a description is given of an example of the form of a license file issued by the license management server 104 shown in FIG. 1.

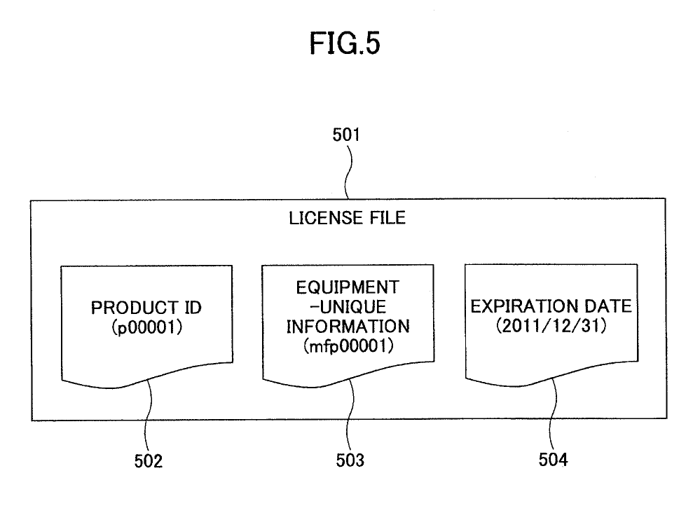

FIG. 5 is an explanatory diagram showing the example of the form of the license file.

A license file 501 is composed of a product ID 502, equipment-unique information 503, and an expiration date 504.

The product ID 502 represents the product ID of software available with the license file 501. Here, the product ID 502 is indicated as “p00001.”

The equipment-unique information 503 represents equipment-unique information on equipment to which the license file 501 is applicable. That is, the license file 501 is applicable only to the equipment holding the same equipment-unique information 503. Here, the equipment-unique information 503 is indicated as “mfp00001.”

The expiration date 504 represents the expiration date of a license obtained when the license file 501 is applied. Here, the expiration date 504 is indicated as “2011 Dec. 31.”

The configuration of the license file is an example, and information other than the above information may be added. For example, if there are plural license contract modes, information on the plural license contract modes may be added.

(Example of Updating License Management Information Held by License Management Server)

Next, a description is given of an example of updating the license management information held by the license management server 104 shown in FIG. 1.

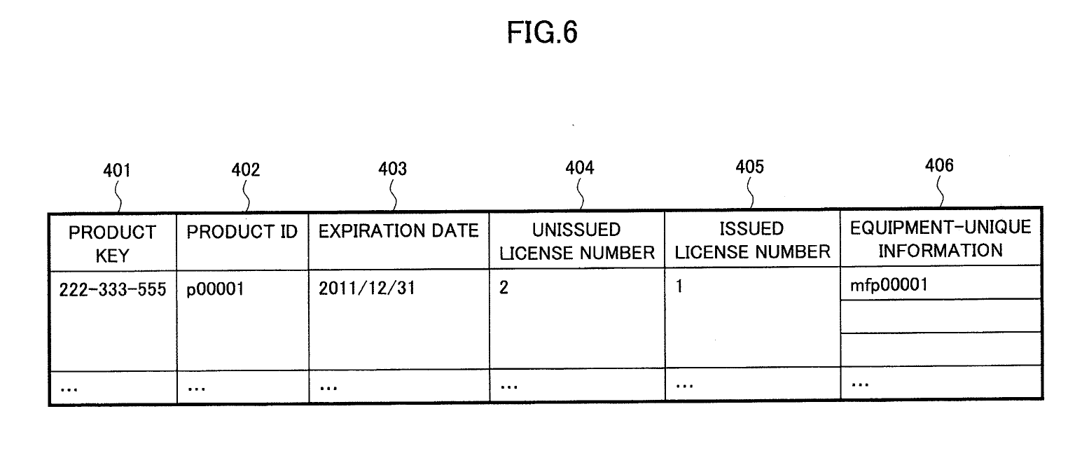

FIG. 6 is an explanatory diagram showing the example of updating the license management information.

When the license file shown in FIG. 5 is issued from the license management server 104, the equipment-unique information 406 held by the license management server 104 is changed from “nothing” to “mfp00001” shown in FIG. 6. In this example, the equipment-unique information 406 is held by the license management server 104, the unissued license number 404 is changed from “3” to “2,” and the issued license number 405 is changed from “0” to “1.”

(Example of License Information Stored in Storage Unit of Management Apparatus)

Next, a description is given of an example of license information stored in the storage unit 203 of the management apparatus 102 shown in FIG. 1.

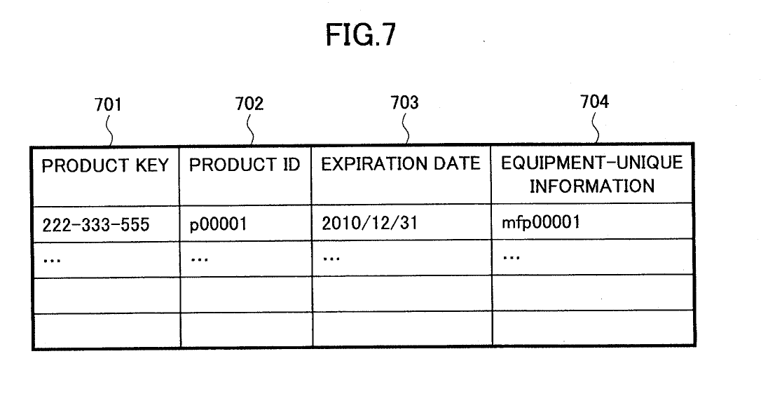

FIG. 7 is an explanatory diagram showing the example of the license information.

Data stored in the storage unit 203 of the management apparatus 102 include the license information. The license information is composed of a product key 701, a product ID 702, an expiration date 703, and an equipment-unique information 704.

As the license information, the license information where activation is requested by the user via the management center 105 in the past is stored.

The product key 701, the product ID 702, the expiration date 703, and the equipment-unique information 704 are the same in meaning as the product key 401, the product ID 402, the expiration date 403, and the equipment-unique information 406 shown in FIG. 6, respectively.

(Example of Operating Sequence Periodically Performed)

Next, a description is given of an example of an operating sequence periodically performed in the information processing apparatus management system shown in FIG. 1.

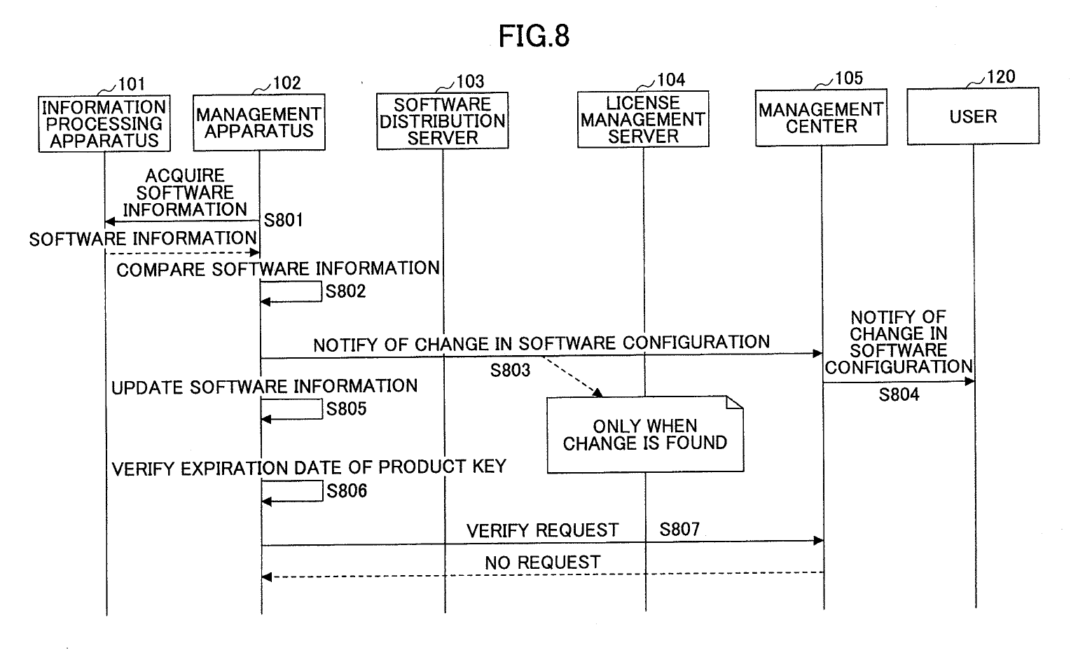

FIG. 8 is a sequence diagram showing the example of the operating sequence.

The acquisition of software information (S801) is periodically performed by the management apparatus 102 with respect to the information processing apparatus 101 at regular intervals. At this time, the management apparatus 102 makes a request to the information processing apparatus 101 for providing the software information. Accordingly, the management apparatus 102 receives information on firmware and plug-ins installed (introduced) in the information processing apparatus 101 as the software information (FIG. 3) from the information processing apparatus 101.

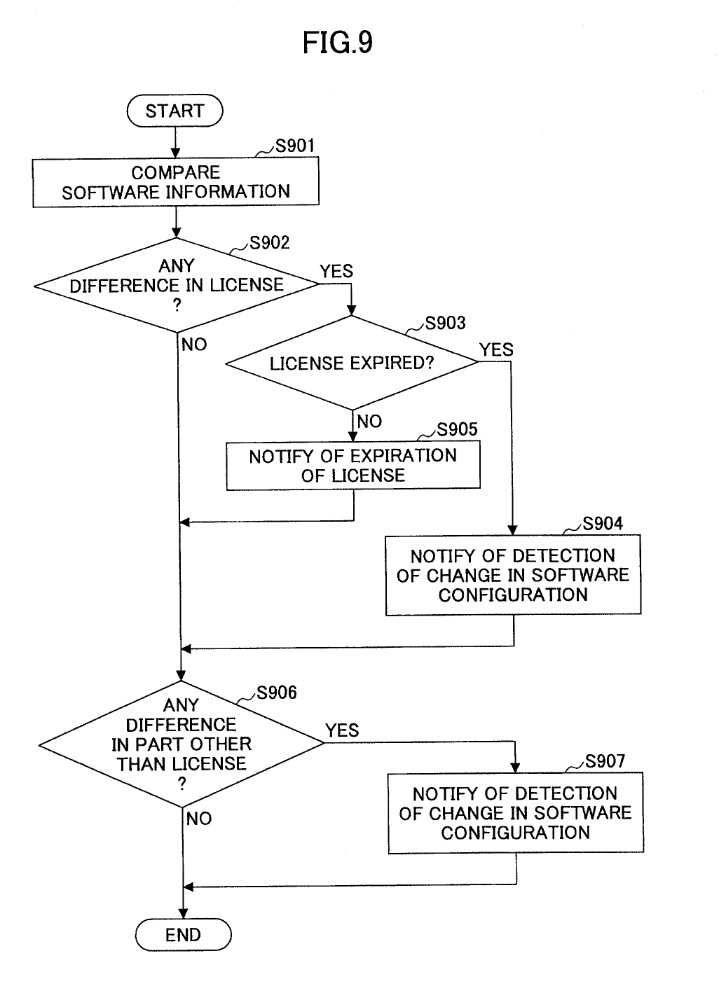

The comparison of the software information (S802) is made in the management apparatus 102. That is, the management apparatus 102 compares software information stored in the storage unit 203 of the management apparatus 102 with the software information acquired in the acquisition of the software information (S801). The procedure of the comparison is described in FIG. 9.

The notification of a change in software configuration (S803) is made by the management apparatus 102 with respect to the management center 105. Only when any change is found in the software information in the comparison of the software information (S802), the management apparatus 102 notifies the management center 105 of information on the change.

The notification of the change in the software configuration (S804) is made by the management center 105 with respect to the user 120. If the change is found in the software information in the comparison of the software information (S802) and the notification of the change in the software configuration (S803) is made, the management center 105 notifies the user 120 of the information on the change. Actually, the notification to the user 120 is made in such a manner that the information on the change is transmitted to user's equipment (equipment set as a notification destination in advance) such as the information processing apparatus 101, a PC (such as a notebook computer) (not shown), and a mobile phone.

The update of the software information (S805) is made in the management apparatus 102. That is, the management apparatus 102 updates the software information stored in the storage unit 203 of the management apparatus 102 with the software information acquired in the acquisition of the software information (S801).

The verification of the expiration date of a product key (S806) is made in the management apparatus 102. That is, the management apparatus 102 verifies the expiration date of license information (FIG. 7) stored in the storage unit 203 of the management apparatus 102. That is, the management apparatus 102 compares the expiration date with current time (for example, a year, a month, a date, an hour, a minute, and a second) and deletes the license information corresponding to the product key of which the time has expired the expiration date.

Here, the management apparatus 102 can acquire the current time from a clocking circuit (not shown) as a clocking unit. Also, the management apparatus 102 may use a clock as software under a program (limited to a UNIX™ type OS, however). The UNIX type OS (including Linux) has time information as a passing second since January 1 in 1970 at 0:00. Therefore, even if no clocking circuit is provided, a counter with which a second can be counted enables the UNIX type OS to perform clocking to acquire current time.

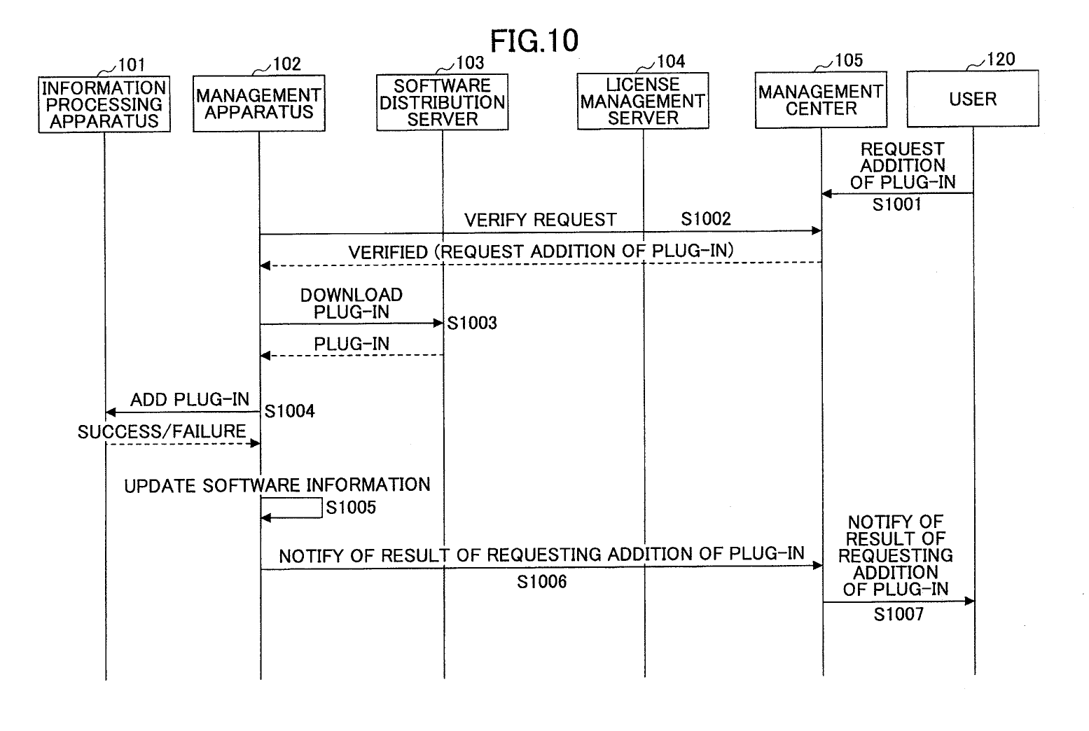

The verification of a request (S807) is made by the management apparatus 102 with respect to the management center 105. That is, the management apparatus 102 verifies the request by the user 120 accumulated in the management center 105. In this example, “no request is made” is verified. An example of “request is made” is described below with respect to FIGS. 10 through 15.

The management apparatus 102 periodically performs the above processing at regular intervals. Thus, the management apparatus 102 can verify the software information on the information processing apparatus 101 and notify, if any change is found in the software information, the management center 105 of the change.

(Example of Procedure of Comparison of Software Information by Management Apparatus)

Next, a description is given of the procedure of the comparison of the software information (S802) by the management apparatus 102 shown in FIG. 1.

FIG. 9 is a flowchart showing an example of the procedure of comparing the software information (S802).

In step S901, the management apparatus 102 compares the software information stored in the storage unit 203 of the management apparatus 102 with the software information acquired in the acquisition of the software information (S801).

In step S902, the management apparatus 102 pays particular attention to the licenses of the compared software information and determines where there is any difference in the licenses. A specific difference represents disagreement in the presence or absence of the license.

In step S903, with respect to the license determined to have the difference in step S902 has expired, the management apparatus 102 determines whether the license.

If the license has not expired, the management apparatus 102 determines that the difference has occurred in the license because of an unintended change made to the software information, and proceeds to step S904. For example, if the presence or absence of the license is changed from “NO” to “YES,” it represents that a plug-in has been activated by a subject other than the management apparatus 102. If the presence or absence of the license has been changed from “YES” to “NO” and the expiration date of the license where the presence or absence of the license is “YES” is a future date (after this determination date), it represents that the plug-in has been activated by a subject other than the management apparatus 102.

If the license has been expired, the management apparatus 102 determines that the difference has occurred in the license because of the expiration of the license, and proceeds to step S905. For example, if the presence or absence of the license is changed from “YES” to “NO” and the expiration date of the license where the presence or absence of the license is “YES” is a past date (before this determination date), it represents that the status of the license of the equipment has been automatically changed by the expiration of the license. That is, the status of the license is not intentionally changed.

In step S904, the management apparatus 102 notifies of the detection of the change in the software configuration. This corresponds to the notification of the change in the software configuration (S803) shown in FIG. 8.

If the presence or absence of the license has been changed from “NO” to “YES,” the management apparatus 102 notifies of the occurrence of the unintended activation of the plug-in.

If the presence or absence of the license has been changed from “YES” to “NO,” the management apparatus 102 notifies of the occurrence of the unintended deactivation of the plug-in.

In step S905, the management apparatus 102 notifies of the expiration of the license. This corresponds to the notification of the change in the software configuration (S803). At this time, the management apparatus 102 notifies of the occurrence of the expiration of the license.

In step S906, the management apparatus 102 pays particular attention to parts other than the licenses of the compared software information and determines whether there is any difference between the software information. A specific difference represents an excess or deficiency in a list of product IDs and a change in version.

In step S907, the management apparatus 102 notifies of the detection of the change in the software configuration. This corresponds to the notification of the change in the software configuration (S803).

If there is any excess in product ID, the management apparatus 102 notifies of the occurrence of the unintended addition of a plug-in.

On the other hand, if there is any deficiency in product ID, the management apparatus 102 notifies of the occurrence of the unintended update of the plug-in.

Further, if there is any change in version, the management apparatus 102 notifies of the occurrence of the unintended update of the plug-in.

(Example of Operating Sequence Performed When Plug-in Addition Request is Made)

Next, a description is given of an example of an operating sequence performed when a plug-in addition request is made in the information processing management system shown in FIG. 1.

FIG. 10 is a sequence diagram showing the example of the operating sequence.

The user requests the addition of the plug-in either in a case where he/she receives the notification of a change in software (occurrence of unintended deletion of the plug-in) from the management center 105 or regardless of the notification of the change in the software. In either case, the operating sequence is the same. Actually, the user's request is made by the operations of the equipment that the user 120 uses.

A plug-in addition request (S1001) is made by the user 120 with respect to the management center 105. At this time, the user 120 specifies the product ID and version of the plug-in to be added and the object information processing apparatus 101. Note that in this embodiment, specification information such as the product ID specified by the user 120 is added to a request such as the plug-in addition request. However, the specification information may not be added to the request.

The verification of the request (S1002) is made by the management apparatus 102 with respect to the management center 105. This is the same as the verification of the request (S807) shown in FIG. 8. That is, the management apparatus 102 performs the verification of the request (S1002) as processing periodically performed by the management apparatus 102 at regular intervals. Accordingly, the management apparatus 102 can find (recognize) the request by the user 120. Further, the management apparatus 102 can find (detect) the product ID and version of the plug-in specified by the request and the object information processing apparatus 101. Note that if the specification information is not added to the request, the specification information is transmitted to the management center 105 when management apparatus 102 performs the verification of the request. Accordingly, the management apparatus 102 can find the specification information.

The download of the plug-in (S1003) is made by the management apparatus 102 with respect to the software distribution server 103. At this time, the management apparatus 102 downloads the plug-in of the product ID and version specified in the plug-in addition request (S1001). The addition of the plug-in (S1004) is made by the management apparatus 102 with respect to the information processing apparatus 101. At this time, the management apparatus 102 transmits the plug-in downloaded in the download of the plug-in (S1003) to the information processing apparatus 101 and makes a request to the information processing apparatus 101 for adding the plug-in. The information processing apparatus 101 performs the addition processing of the received plug-in and returns a success/failure as a result of the addition processing to the management apparatus 102.

The update of software information (S1005) is made in the management apparatus 102. At this time, the management apparatus 102 updates the software information stored in the storage unit 203 and adds information on the plug-in added in the addition of the plug-in (S1004). This processing is performed if the addition of the plug-in (S1004) is successful and not performed if it fails.

The notification of the result of the plug-in addition request (S1006) is made by the management apparatus 102 with respect to the management center 105. At this time, the management apparatus 102 notifies the management center 105 of the result of the addition of the plug-in (S1004).

The notification of the result of the plug-in addition request (S1007) is made by the management center 105 with respect to the user 120. At this time, the management center 105 notifies the user 120 of the result of the addition of the plug-in (S1004).

In the operating sequence shown in FIG. 10, the user 120 makes the addition request of the plug-in. However, when the user makes an update request of the plug-in, the same operating sequence in which the “addition” is replaced by “update” is performed. Further, when the user 120 makes the update request of firmware, the same operating sequence in which the “addition of the plug-in” is replaced by the “update of the firmware.”

(Example of Operating Sequence Performed When Plug-in Deletion Request is Made)

Next, a description is given of an example of an operating sequence performed when a plug-in deletion request is made in the information processing apparatus management system shown in FIG. 1.

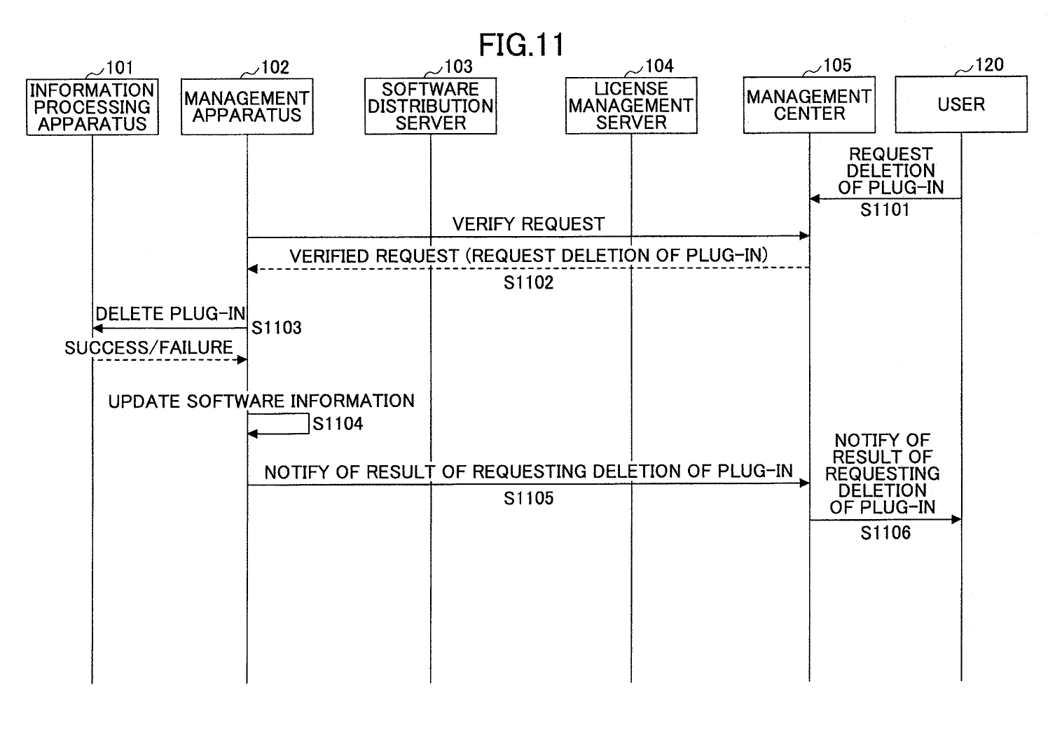

FIG. 11 is a sequence diagram showing the example of the operating sequence.

The user requests the deletion of the plug-in either in a case where he/she receives the notification of a change in software (occurrence of unintended deletion of the plug-in) from the management center 105 or regardless of the notification of the change in the software. In either case, the operating sequence is the same.

A plug-in deletion request (S1101) is made by the user 120 with respect to the management center 105. At this time, the user 120 specifies the product ID of the plug-in to be deleted and the object information processing apparatus 101.

The verification of the request (S1102) is made by the management apparatus 102 with respect to the management center 105. This is the same as the verification of the request (S807) shown in FIG. 8. That is, the management apparatus 102 performs the verification of the request (S1102) as processing periodically performed by the management apparatus 102 at regular intervals. Accordingly, the management apparatus 102 can find (recognize) the request by the user 120. Further, the management apparatus 102 can also find the product ID of the plug-in specified by the request and the object information processing apparatus 101.

The deletion of the plug-in (S1103) is made by the management apparatus 102 with respect to the information processing apparatus 101. At this time, the management apparatus 102 transmits the product ID specified in the plug-in deletion request (S1101) to the information processing apparatus 101. The information processing apparatus 101 performs the deletion processing of the plug-in of the received product ID and returns a success/failure as a result of the deletion processing to the management apparatus 102.

The update of software information (S1104) is made in the management apparatus 102. At this time, the management apparatus 102 updates the software information stored in the storage unit 203 and deletes information on the plug-in deleted in the deletion of the plug-in (S1103). This processing is performed if the deletion of the plug-in (S1103) is successful and not performed if it fails.

The notification of the result of the plug-in deletion request (S1105) is made by the management apparatus 102 with respect to the management center 105. At this time, the management apparatus 102 notifies the management center 105 of the result of the deletion of the plug-in (S1103).

The Notification of the result of the plug-in deletion request (S1106) is made by the management center 105 with respect to the user 120. At this time, the management center 105 notifies the user 120 of the result of the deletion of the plug-in (S1103).

(Example of Operating Sequence Performed When Plug-in Activation Requested is Made)

Next, a description is given of an example of an operating sequence performed when a plug-in activation request is made in the information processing apparatus management system shown in FIG. 1.

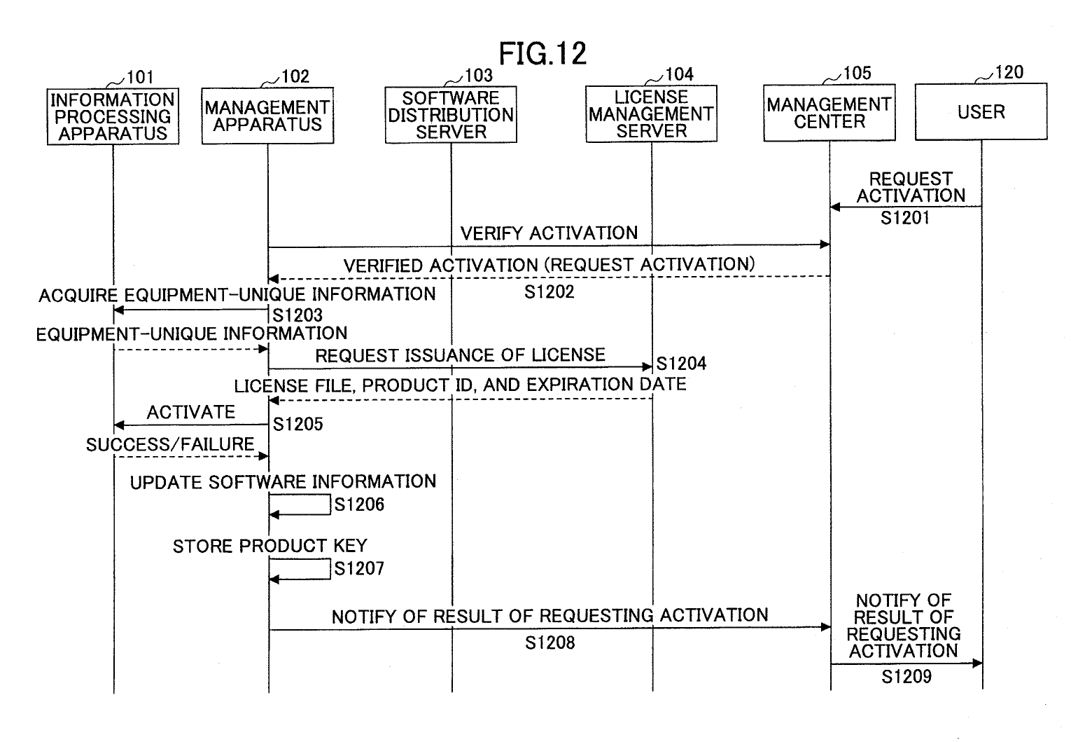

FIG. 12 is a sequence diagram showing the example of the operating sequence.

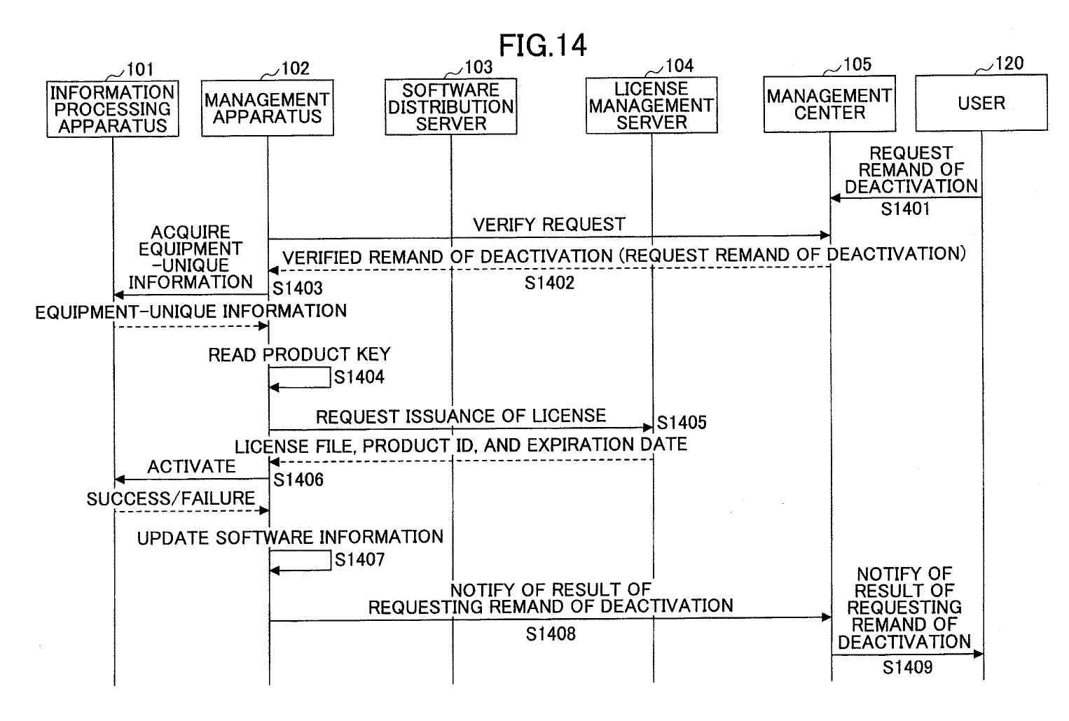

The user requests the activation of a plug-in (1) in a case where he/she receives the notification of a change in software (occurrence of the unintended deactivation of the plug-in) from the management center 105, (2) in a case where he/she receives notification of a change in software (occurrence of the expiration of a license), and (3) regardless of the notification of a change in software. The cases of (2) and (3) are described here, while the case of (1) is described below with reference to FIG. 14.

An activation request (S1201) is made by the user 120 with respect to the management center 105. At this time, the user 120 specifies the product key of a plug-in to be activated and the object information processing apparatus 101.

The verification of the request (S1202) is made by the management apparatus 102 with respect to the management center 105. This is the same as the verification of the request (S807) shown in FIG. 8. That is, the management apparatus 102 makes the verification of the request (S1202) as processing periodically performed by the management apparatus 102 at regular intervals. Accordingly, the management apparatus can find the request by the user 120. Further, the management apparatus 102 can also find the product key of the plug-in to be specified and equipment specification information (such as an IP address) on the object information processing apparatus 101.

The acquisition of equipment-unique information (S1203) is made by the management apparatus 102 with respect to the object information processing apparatus 101. At this time, the management apparatus 102 transmits the provision request of the equipment-unique information to the information processing apparatus 101, and then the information processing apparatus 101 returns the equipment-unique information thereof to the management apparatus 102. Accordingly, the management apparatus 102 receives the equipment-unique information.

A license issuance request (S1204) is made by the management apparatus 102 with respect to the license management server 104. At this time, the management apparatus 102 transmits the product key specified in the activation request (S1201) and the equipment-unique information acquired in the acquisition of the equipment-unique information (S1203) to the license management server 104 to request the issuance of a license file. In response to the request, the license management server 104 finds a product ID and an expiration date based on the received product key, and generates the license file with the product ID, the expiration date, and the received equipment-unique information. Then, the license management server 104 returns the generated license file, the product ID, and the expiration data to the management apparatus 102, increments the number of issued licenses corresponding to the received product key by one, and adds the received equipment-unique information.

Activation (S1205) is made by the management apparatus 102 with respect to the information processing apparatus 101. At this time, the management apparatus 102 transmits the license file acquired in the license issuance request (S1204) to the information processing apparatus 101 to request the activation of the plug-in. In response to the request, the information processing apparatus 101 determines whether the equipment-unique information held by the information processing apparatus 101 and the equipment-unique information configuring the received license file match each other. The information processing apparatus 101 performs activation processing upon verifying that they match each other, and then returns a success/failure as a result of the processing to the management apparatus 102.

The update of software information (S1206) is made in the management apparatus 102. At this time, the management apparatus 102 updates the software information stored in the storage unit 203 and sets the product ID and the expiration date returned in the license issuance request (S1204) to change the license information to “YES.” This processing is performed if the activation (S1205) is successful and is not performed if it fails.

The storage of the product key (S1207) is made in the management apparatus 102. At this time, the management apparatus 102 stores in the storage unit 203 the product key specified in the activation request (S1201) and the expiration date returned in the license issuance request (S1204).

The notification of the result of the activation request (S1208) is made by the management apparatus 102 with respect to the management center 105. At this time, the management apparatus 102 notifies the management center 105 of the result of the activation (S1205).

The notification of the result of the activation (S1209) is made by the management center 105 with respect to the user 120. At this time, the management center 105 notifies the user 120 of the result of the activation (S1205).

(Example of Operating Sequence Performed When Plug-in Deactivation Requested is Made)

Next, a description is given of an example of an operating sequence performed when a plug-in deactivation request is made in the information processing apparatus management system shown in FIG. 1.

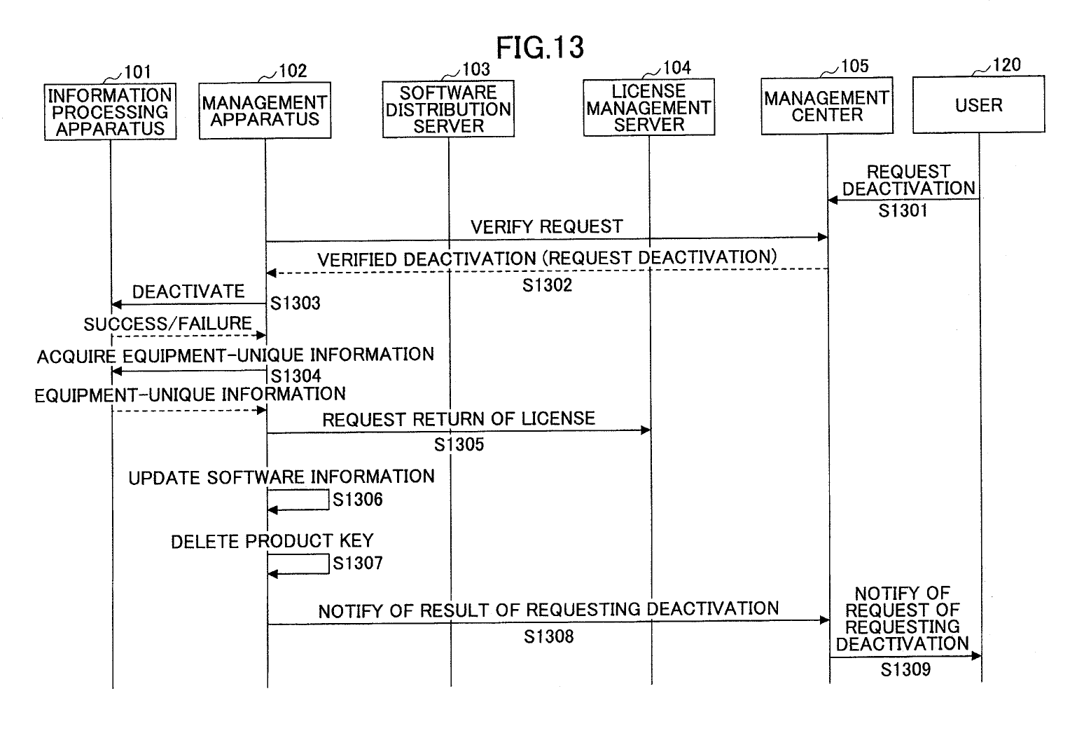

FIG. 13 is a sequence diagram showing the example of the operating sequence.

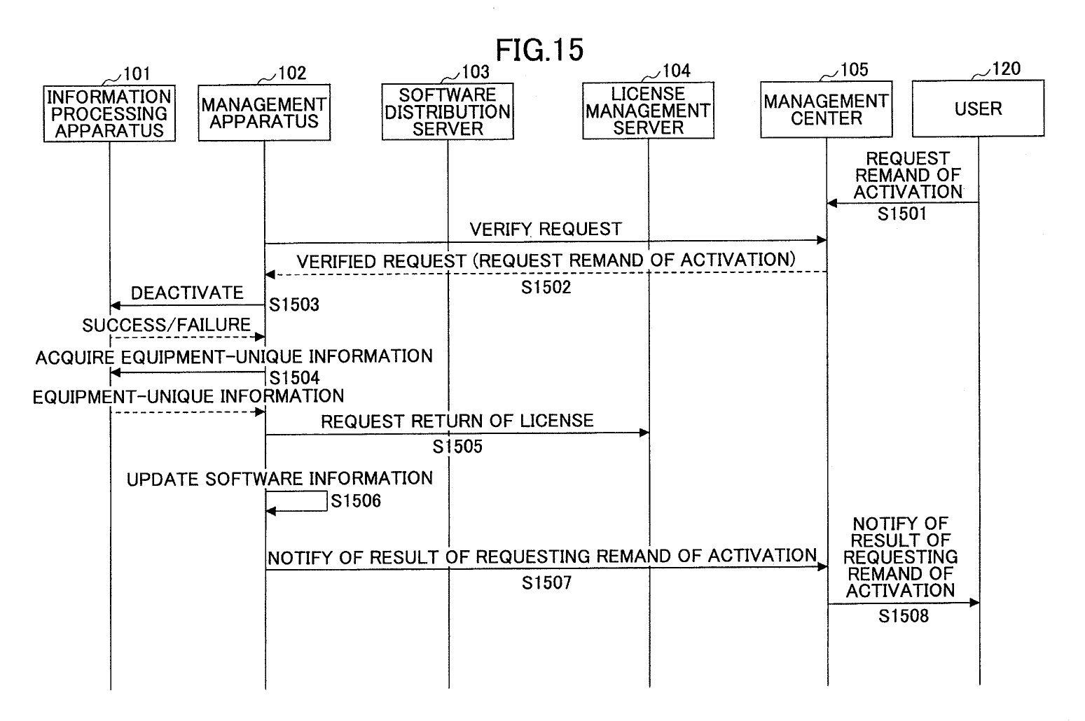

The user requests the deactivation of a plug-in (1) in a case where he/she receives the notification of a change in software (occurrence of the unintended activation of the plug-in) from the management center 105 and (2) regardless of the notification of a change in software. The case of (2) is described here, while the case of (1) is described below with reference to FIG. 15.

A deactivation request (S1301) is made by the user 120 with respect to the management center 105. At this time, the user 120 specifies the product ID of an object to be deactivated and the object information processing apparatus 101.

The verification of the request (S1302) is made by the management apparatus 102 with respect to the management center 105. This is the same as the verification of the request (S807) shown in FIG. 8. That is, the management apparatus 102 makes the verification of the request (S1302) as processing periodically performed by the management apparatus 102 at regular intervals. Accordingly, the management apparatus can find the request by the user 120. Further, as a result of the request, the management apparatus 102 can also find the product ID of the specified plug-in and equipment specification information on the object information processing apparatus 101.

Deactivation (S1303) is made by the management apparatus 102 with respect to the object information processing apparatus 101. At this time, the management apparatus 102 transmits the object product ID specified in the deactivation request (S1301) to the object information processing apparatus 101. The information processing apparatus 101 performs The deactivation processing of the plug-in of the received product ID, and then returns a success/failure as a result of the processing to the management apparatus 102.

The acquisition of equipment-unique information (S1304) is made by the management apparatus 102 with respect to the object information processing apparatus 101. At this time, the management apparatus 102 transmits the provision request of the equipment-unique information to the information processing apparatus 101, and then the object information processing apparatus 101 returns the equipment-unique information thereof to the management apparatus 102. Accordingly, the management apparatus 102 receives the equipment-unique information.

A license return request (S1305) is made by the management apparatus 102 with respect to the license management server 104. At this time, the management apparatus 102 transmits the product ID specified in the deactivation request (S1301) and the equipment-unique information acquired in the acquisition of the equipment-unique information (S1304) to the license management server 104 to request the return of a license. In response to the response, the license management server 104 specifies a product key with the received product ID and the equipment-unique information, subtracts the number of issued licenses corresponding to the product key by one, and deletes equipment-unique information matching the received equipment-unique information.

The update of software information (S1306) is made in the management apparatus 102. At this time, the management apparatus 102 updates the software information stored in the storage unit 203, changes the license information on the plug-in deactivated in the deactivation (S1303) to “NO,” and changes the expiration of the software information to “N/A.” This processing is performed if the deactivation (S1303) is successful and is not performed if it fails.

The Deletion of the product key (S1307) is made in the management apparatus 102. At this time, the management apparatus 102 verifies the expiration date stored in the storage unit 203 and deletes the corresponding product key if the expiration date is a past date. That is, the management apparatus 102 deletes from the storage unit 203 the license key corresponding to the product ID specified in the deactivation request (S1301) and the equipment-unique information acquired in the acquisition of the equipment-unique information (S1304).

The notification of the result of the deactivation request (S1308) is made by the management apparatus 102 with respect to the management center 105. At this time, the management apparatus 102 notifies the management center 105 of the result of the deactivation (S1303).

The notification of the result of the deactivation request (S1309) is made by the management center 105 with respect to the user 120. At this time, the management center 105 notifies the user of the result of the deactivation (S1303).

(Example of Operating Sequence Performed When Deactivation Remand Request is Made)

Next, a description is given of an example of an operating sequence performed when a deactivation remand request is made in the information processing apparatus management system shown in FIG. 1.

FIG. 14 is a sequence diagram showing the example of the operating sequence.

This represents the operating sequence performed when the user 120 remands (cancels) deactivation after receiving the notification of a change in software configuration from the management center 105 (occurrence of the unintended deactivation of a plug-in), i.e., when the user 120 requests activation.

A deactivation remand request (S1401) is made by the user 120 with respect to the management center 105. At this time, the user 120 specifies the product ID of an object to be activated and the object information processing apparatus 101.

The verification of the request (S1402) is made by the management apparatus 102 with respect to the management center 105. This is the same as the verification of the request (S807) shown in FIG. 8. That is, the management apparatus 102 makes the verification of the request (S1402) as processing periodically performed by the management apparatus 102 at regular intervals. Accordingly, the management apparatus can find the request by the user 120. Further, as a result of the request, the management apparatus 102 can also find the specified product ID of the plug-in of the specified object and equipment specification information on the object information processing apparatus 101.

The acquisition of equipment-unique information (S1403) is made by the management apparatus 102 with respect to the object information processing apparatus 101. At this time, the management apparatus 102 transmits the provision request of the equipment-unique information to the information processing apparatus 101, and then the information processing apparatus 101 returns the equipment-unique information thereof to the management apparatus 102. Accordingly, the management apparatus 102 receives the equipment-unique information.

The read of a product key (S1404) is made in the management apparatus 102. At this time, the management apparatus 102 reads the corresponding product key from the license information stored in the storage unit 203 based on the object product ID specified in the deactivation remand request (S1401) and the equipment-unique information acquired in the acquisition of the equipment-unique information (S1403).

A license issuance request (S1405) is made by the management apparatus 102 with respect to the license management server 104. At this time, the management apparatus 102 transmits the product key read in the read of the product key (S1404) and the equipment-unique information acquired in the acquisition of the equipment-unique information (S1403) to the license management server 104 to request the issuance of a license file. In response to the request, the license management server 104 finds a product ID and an expiration date based on the received product key, and generates the license file with the product ID, the expiration date, and the received equipment-unique information. Then, the license management server 104 returns the generated license file, the product ID, and the expiration data to the management apparatus 102, increments the number of issued licenses corresponding to the received product key by one, and adds the received equipment-unique information.

Activation (S1406) is made by the management apparatus 102 with respect to the information processing apparatus 101. At this time, the management apparatus 102 transmits the license file acquired in the license issuance request (S1405) to the information processing apparatus 101 to request the activation of the plug-in. In response to the request, the information processing apparatus 101 determines whether the equipment-unique information held by the information processing apparatus 101 and the equipment-unique information configuring the received license file match each other. The information processing apparatus 101 performs activation processing upon verifying that they match each other, and then returns a success/failure as a result of the processing to the management apparatus 102.

The update of software information (S1407) is made in the management apparatus 102. At this time, the management apparatus 102 updates the software information stored in the storage unit 203 and sets the product ID and the expiration date returned in the license issuance request (S1405) to change the license information to “YES.” This processing is performed if the activation (S1406) is successful and is not performed if it fails.

The notification of the result of the deactivation remand request (S1408) is made by the management apparatus 102 with respect to the management center 105. At this time, the management apparatus 102 notifies the management center 105 of the result of the activation (S1406).

The notification of the result of the deactivation remand request (S1409) is made by the management center 105 with respect to the user 120. At this time, the management center 105 notifies the user 120 of the result of the activation (S1406).

(Example of Operating Sequence Performed When Activation Remand Request is Made)

Next, a description is given of an example of an operating sequence performed when an activation remand request is made in the information processing apparatus management system shown in FIG. 1.

FIG. 15 is a sequence diagram showing the example of the operating sequence.

This represents the operating sequence performed when the user 120 remands activation after receiving the notification of a change in software configuration from the management center 105 (occurrence of the unintended activation of a plug-in), i.e., when the user 120 requests deactivation.

An activation remand request (S1501) is made by the user 120 with respect to the management center 105. At this time, the user 120 specifies the product ID of an object to be deactivated and the object information processing apparatus 101.

The verification of the request (S1502) is made by the management apparatus 102 with respect to the management center 105. This is the same as the verification of the request (S807) shown in FIG. 8. That is, the management apparatus 102 makes the verification of the request (S1502) as processing periodically performed by the management apparatus 102 at regular intervals. Accordingly, the management apparatus can find the request by the user 120. Further, as a result of the request, the management apparatus 102 can also find the product ID of the plug-in of specified object and equipment specification information on the object information processing apparatus 101.

Deactivation (S1503) is made by the management apparatus 102 with respect to the object information processing apparatus 101. At this time, the management apparatus 102 transmits the product ID specified in the activation remand request (S1501) to the information processing apparatus 101. The information processing apparatus 101 performs the deactivation processing of the plug-in of the received product ID, and then returns a success/failure as a result of the processing to the management apparatus 102.

The acquisition of equipment-unique information (S1504) is made by the management apparatus 102 with respect to the object information processing apparatus 101. At this time, the management apparatus 102 transmits the provision request of the equipment-unique information to the information processing apparatus 101, and then the information processing apparatus 101 returns the equipment-unique information thereof to the management apparatus 102. Accordingly, the management apparatus 102 receives the equipment-unique information.

A license return request (S1505) is made by the management apparatus 102 with respect to the license management server 104. At this time, the management apparatus 102 transmits the product ID specified in the activation remand request (S1501) and the equipment-unique information acquired in the acquisition of the equipment-unique information (S1504) to the license management server 104 to request the return of a license. In response to the response, the license management server 104 specifies a product key with the received product ID and the equipment-unique information, subtracts the number of issued licenses corresponding to the product key by one, and deletes equipment-unique information matching the received equipment-unique information.

The update of software information (S1506) is made in the management apparatus 102. At this time, the management apparatus 102 updates the software information stored in the storage unit 203, changes the license information on the plug-in deactivated in the deactivation (S1303) to “NO,” and changes the expiration of the software information to “N/A.” This processing is performed if the deactivation (S1205) is successful and is not performed if it fails.

The notification of the result of the activation remand request (S1507) is made by the management apparatus 102 with respect to the management center 105. At this time, the management apparatus 102 notifies the management center 105 of the result of the deactivation (S1503).

The notification of the result of the activation remand request (S1508) is made by the management center 105 with respect to the user 120. At this time, the management center 105 notifies the user 120 of the result of the deactivation (S1503).

As described above, the management apparatus 102 has the storage unit 203 that stores software information and license information, and periodically acquires from the information processing apparatus 101 information on software introduced into the information processing apparatus 101 capable of communicating with the management apparatus 102. The management apparatus 102 compares the acquired software information with the software information stored in the storage unit 203, and notifies, if a difference between these software information is found, the user 120 of the detection of a change in software configuration and updates the corresponding software information stored in the storage unit 203 with the acquired software information. Then, when receiving the change request of the software configuration from the user 120, the management apparatus 102 makes a request to the information processing apparatus 101 for changing the software configuration with the corresponding license information stored in the storage unit 203 and notifies the user 120 of the result of the request. Accordingly, if an unintended change in the software configuration is made by a subject other than the management apparatus 102 in the information processing apparatus 101, the management apparatus 102 can restore the software configuration to its unchanged status. That is, even when the unintended change in the software configuration is made by a subject other than the management apparatus 102 in the information processing apparatus 101, the management apparatus 102 can detect the change and recover the software configuration.

The above embodiment describes, as an example of the electronic equipment management system including the management apparatus 102 according to the present invention, the information processing apparatus management system that manages the information processing apparatus 101 with the management apparatus 102. The embodiment of the present invention is not limited to this but is also applicable to an electronic equipment management system that regards, as apparatuses to be managed, various electronic equipment including computers connectable to networks and embedded equipment such as home electric appliances, vending machines, medical devices, power supply devices, air conditioning systems, metering systems for gas, water, electricity, or the like, AV equipment, and playing equipment and that manages the apparatuses to be managed with a management apparatus.

(Program Related to the Present Invention)

The program causes the CPU, which is a computer for controlling the management apparatus, to realize the functions of the information acquisition unit, the difference detection unit, the change-detection notification unit, the information update unit, the request detection unit, the change request unit, the request-result notification unit, the license file request unit, the license file acquisition unit, the license return request unit, the product-key read unit, the time acquisition unit, the comparison unit, and the information deletion unit, all of which are related to the present invention. When the CPU 201 executes such a program, the above functions and effects can be obtained.

Such a program may be stored in a ROM previously provided in the management apparatus, a non-volatile memory (such as a flash ROM and an EEPROM), or a storage unit such as a HDD. Alternatively, it may be recorded in a CD-ROM serving as a recording medium or a non-volatile recording medium (memory) such as a memory card, a flexible disk, a MO, a CD-R, a CD-RW, a DVD+R, a DVD+RW, a DVD-R, a DVD-RW, and a DVD-RAM. The above respective procedures can be executed in such a manner that the program recorded in such a recording medium is installed in the management apparatus and executed by the CPU or the CPU reads the program from the recording medium and executes the same.

Moreover, the above respective procedures can also be executed in such a manner that the program is downloaded from external equipment connected to a network and having a recording medium recording the program or from external equipment connected to the network and having a storage unit storing the program.

As is clear from the above description, the embodiment of the present invention enables the management apparatus to detect and recover an unintended change in software configuration by a subject other than the management apparatus in electronic equipment capable of being connected to the management apparatus. Accordingly, the embodiment of the present invention can provide a management apparatus capable of operating electronic equipment with optimum software configuration at all times and an electronic equipment management system including the management apparatus.

The present invention is not limited to the specifically disclosed embodiments, and variations and modifications may be made without departing from the scope of the present invention.

The present application is based on Japanese Priority Application No. 2010-146266 filed on Jun. 28, 2010, the entire contents of which are hereby incorporated herein by reference.

What is claimed is:

1. A management apparatus that manages electronic equipment connected via a connection unit, the management apparatus comprising:
the connection unit configured to be communicably connected to the electronic equipment;
a storage unit configured to store software information and license information;
an information acquisition unit configured to periodically acquire software information introduced into the electronic equipment from the electronic equipment;
a difference detection unit configured to compare the software information acquired by the information acquisition unit with the software information stored in the storage unit and to detect a difference between the respective software information;
a change-detection notification unit configured to notify a user of a detection of a change in a software configuration when the difference is detected by the difference detection unit;
an information update unit configured to update the corresponding software information stored in the storage unit with the software information acquired by the information acquisition unit;
a request detection unit configured to detect a change request of the software configuration from the user;
a change request unit configured to make a request to the electronic equipment for changing the software configuration with the corresponding license information stored in the storage unit when the request detection unit detects the change request of the software configuration; and
a request-result notification unit configured to notify the user of a result of the request by the change request unit.

2. The management apparatus according to claim 1, wherein
the connection unit includes
a unit configured to be communicably connected to a license management server that manages a license for using specific software introduced into the electronic equipment,
the request detection unit includes
a unit configured to detect specification information from the user when detecting the change request of the software configuration from the user, and
the information acquisition unit includes
a unit configured to acquire equipment-unique information from the electronic equipment indicated by equipment specification information when the request detection unit detects an activation request of the software as the change request of the software configuration and detects the equipment specification information and a product key of the electronic equipment as the specification information,
the management apparatus further comprises
a license file request unit configured to transmit the product key detected by the request detection unit and the equipment-unique information acquired by the information acquisition unit to the license management server to request an issuance of a license file, and
a license file acquisition unit configured to acquire the license file issued by the license management server in response to the request by the license file request unit,
the change request unit includes
a unit configured to transmit the license file acquired by the license file acquisition unit to the electronic equipment indicated by the equipment specification information detected by the request detection unit to request an activation of the software, and
the information update unit includes
a unit configured to add the product key detected by the request detection unit to the corresponding license information stored in the storage unit.

3. The management apparatus according to claim 2, wherein
the change request unit includes
a unit configured to transmit a product ID to the electronic equipment indicated by the equipment specification information to request a deactivation of the software when the request detection unit detects the deactivation request of the software as the change request of the software configuration and detects the equipment specification information and the product ID of the electronic equipment as the specification information,
the information acquisition unit includes
a unit configured to acquire the equipment-unique information from the electronic equipment indicated by the equipment specification information detected by the request detection unit together with the deactivation request of the software,
the management apparatus further comprises
a license return request unit configured to transmit the product ID detected by the request detection unit together with the deactivation request of the software and the equipment-unique information acquired by the information acquisition unit to the license management server to request a return of the license, and
the information update unit includes
a unit configured to delete the product ID detected by the request detection unit together with the deactivation request of the software and the license key corresponding to the equipment-unique information acquired by the information acquisition unit from the corresponding license information stored in the storage unit.

4. The management apparatus according to claim 3, wherein
the change request unit includes
a unit configured to acquire the equipment-unique information from the electronic equipment indicated by the equipment specification information when the request detection unit detects a deactivation cancel request of the software as the change request of the software configuration and detects the equipment specification information and the product ID of the electronic equipment as the specification information,
the management apparatus further comprises
a product-key read unit configured to read the product key from the corresponding license information stored in the storage unit based on the product ID detected by the request detection unit together with the deactivation cancel request of the software and the equipment-unique information acquired by the information acquisition unit, and
the license file request unit includes
a unit configured to transmit the product key read by the product-key read unit and the equipment-unique information acquired by the information acquisition unit to the license management server to request the issuance of the license file.

5. The management apparatus according to claim 3, wherein
the change request unit includes
a unit configured to transmit the product ID to the electronic equipment indicated by the equipment specification information to request a deactivation of the software when the request detection unit detects an activation cancel request of the software as the change request of the software configuration and detects the equipment specific information and the product ID of the electronic equipment as the specification information,
the information acquisition unit includes
a unit configured to acquire the equipment-unique information from the electronic equipment indicated by the equipment specification information detected by the request detection unit together with the activation cancel request of the software, and
the license return request unit includes
a unit configured to transmit the product ID detected by the request detection unit together with the activation cancel request of the software and the equipment-unique information acquired by the information acquisition unit to the license management server to request the return of the license.

6. The management apparatus according to claim 3, wherein
the license information stored in the storage unit is composed of at least the product key and an expiration date, and
the management apparatus further comprises
a time acquisition unit configured to acquire a current time,
a comparison unit configured to compare the current time acquired by the time acquisition unit with the expiration date, and
an information deletion unit configured to delete, as a result of the comparison by the comparison unit, the license information corresponding to the product key of which the expiration period is over from the storage unit.

7. An electronic equipment management system including a license management server and electronic equipment each having a connection unit communicably connected to the management apparatus according to claim 6, wherein
the license management server comprises
a license information storage unit configured to store license information composed of the product key, the product ID, the expiration date, an unissued license number, an issued license number, and the equipment-unique information on the electronic equipment,
a license file issuance unit configured to generate the license file including the corresponding product ID, the equipment-unique information, and the expiration date stored in the license information storage unit based on the product key and the equipment-unique information and transmit the same to the management apparatus, to decrement the corresponding unissued license number stored in the license information storage unit by one, and to increment the corresponding issued license number stored in the license information storage unit by one, when receiving the product key and the equipment-unique information together with the issuance request of the license file from the management apparatus, and
a license return unit configured to increment the corresponding unissued license number stored in the license information storage unit by one and to decrement the corresponding issued license number stored in the license information storage unit by one, when receiving the product ID and the equipment-unique information together with the return request of the license from the management apparatus, and wherein
the electronic equipment comprises
an equipment-unique information storage unit configured to store the equipment-unique information on the electronic equipment,
an equipment-unique information notification unit configured to notify the management apparatus of the equipment-unique information stored in the equipment-unique information storage unit, when receiving an equipment-unique information provision request from the management apparatus,
an equipment-unique information determination unit configured to determine whether the equipment-unique information constituting the license file and the equipment-unique information stored in the equipment-unique information storage unit match each other, when receiving the license file together with the activation request of the software from the management apparatus, and
an activation processing unit configured to perform activation processing when the equipment-unique information determination unit determines that both of the equipment-unique information match each other.

8. A management method of a management apparatus that has a connection unit communicably connected to electronic equipment and a storage unit storing software information and license information and that manages the electronic equipment connected via the connection unit, the management method comprising:
an information acquisition step of periodically acquiring software information introduced into the electronic equipment from the electronic equipment;
a difference detection step of comparing the software information acquired in the information acquisition step with the software information stored in the storage unit and detecting a difference between the respective software information;
a change-detection notification step of notifying a user of a detection of a change in a software configuration when the difference is detected in the difference detection step;
an information update step of updating the corresponding software information stored in the storage unit with the software information acquired in the information acquisition step;
a request detection step of detecting a change request of the software configuration from the user; and
a change request step of making a request to the electronic equipment for changing the software configuration with the corresponding license information stored in the storage unit when the change request of the software configuration is detected in the request detection step.
